(19) United States
(12) Patent Application Publication
(10) Pub. No.: US 2025/0247841 A1
(43) Pub. Date: Jul. 31, 2025

(54) METHOD AND APPARATUS FOR SUPPORTING SIMULTANEOUS USER EQUIPMENT TRANSMISSION ON PLURAL CARRIERS

(71) Applicant: Samsung Electronics Co., Ltd., Gyeonggi-do (KR)

(72) Inventors: Min WU, Beijing (CN); Sa ZHANG, Beijing (CN); Feifei SUN, Beijing (CN)

(21) Appl. No.: 19/037,023

(22) Filed: Jan. 24, 2025

(30) Foreign Application Priority Data
Jan. 26, 2024 (CN) 202410117597.1

(51) Int. Cl. H04W 72/1263; H04W 72/044; H04W 72/232

(52) U.S. Cl. CPC H04W 72/1263; H04W 72/044; H04W 72/232

(57) ABSTRACT

Disclosed is a performed by a user equipment, including receiving downlink control information (DCI), the DCI including scheduling information of a physical downlink shared channel (PDSCH) or physical uplink shared channel (PUSCH) transmitted on at least two bandwidth parts (BWPs), wherein the at least two BWPs including one first BWP and at least one second BWP are configured in one serving cell, and receiving the PDSCH or transmitting the PUSCH scheduled by the DCI on the at least two BWPs.

### CROSS-REFERENCE TO RELATED APPLICATION(S)

This application is based on and claims priority under 35 U.S.C. § 119 to Chinese Patent Application No. 202410117597.1, which was filed in the Chinese Intellectual Property Office on Jan. 26, 2024, the disclosure of which is incorporated herein by reference in its entirety.

### BACKGROUND

### 1. Field

The disclosure relates to wireless communication, and more particularly, to a communication method, a user equipment (UE), and a base station (BS) supporting simultaneous transmissions.

### 2. Description of Related Art

To meet the increasing demand for wireless data communication services since the deployment of fourth generation (4G) communication systems, efforts have been made to develop improved fifth generation (5G) or pre-5G communication systems, also referred to as beyond 4G networks or post long term evolution (LTE) systems.

To achieve a higher data rate, 5G communication systems are implemented in higher frequency millimeter wave (mmWave) bands, e.g., 60 gigahertz (GHz) bands. To reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (COMP), reception-end interference cancellation, etc.

Also, hybrid frequency shift keying (FSK) and quadrature amplitude modulation (QAM) (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

In the existing communication systems, a plurality of carriers can only be deployed by carrier aggregation (CA) or dual-connectivity (DC). In CA/DC, each carrier corresponds to one serving cell, a plurality of carriers are aggregated by aggregating a plurality of serving cells, and a UE can perform simultaneous transmission on the carriers of a plurality of serving cells. However, in such approach of deploying a plurality of carriers, each cell requires the respective signaling overhead, resulting in more complex systems with excessive overhead.

Thus, there is a need in the art for a method and apparatus for improved deployment of plural carriers and decreased overhead in the communication system.

### SUMMARY

The disclosure has been made to address at least the above-mentioned problems and/or disadvantages and to provide at least the advantages described below.

Accordingly, an aspect of the disclosure is to provide a method and apparatus to improve the flexibility of deployment of a plurality of carriers, thereby simplifying the system and decreasing the signaling overhead.

An aspect of the disclosure is to provide a method performed by a UE and a method performed by a BS to enhance the existing multi-carrier technology, and support the simultaneous transmission of the UE on a plurality of carriers in one serving cell.

In accordance with an aspect of the disclosure, a method performed by a user equipment (UE) includes receiving downlink control information (DCI), the DCI including scheduling information of a physical downlink shared channel (PDSCH) or physical uplink shared channel (PUSCH) transmitted on at least two bandwidth parts (BWPs), wherein the at least two BWPs including one first BWP and at least one second BWP are configured in one serving cell, and receiving the PDSCH or transmitting the PUSCH scheduled by the DCI on the at least two BWPs.

In accordance with an aspect of the disclosure, a user equipment in a communication system is provided. The user equipment comprises a transceiver, a memory, and a processor coupled with the transceiver, and the processor configured to receive downlink control information (DCI), the DCI including scheduling information of a physical downlink shared channel (PDSCH) or physical uplink shared channel (PUSCH) transmitted on at least two bandwidth parts (BWPs), wherein the at least two BWPs including one first BWP and at least one second BWP are configured in one serving cell, and receive the PDSCH or transmit PUSCH scheduled by the DCI on the at least two BWPs.

In accordance with an aspect of the disclosure, a method performed by a BS in a communication system includes transmitting downlink control information (DCI), the DCI including scheduling information of physical downlink shared channels (PDSCHs) or physical uplink shared channels (PUSCHs) transmitted on at least two bandwidth parts (BWPs), wherein the at least two BWPs including one first BWP and at least one second BWP are configured in one serving cell, and transmitting the PDSCH or receiving the PUSCH scheduled by the DCI on the at least two BWPs.

### BRIEF DESCRIPTION OF THE DRAWINGS

The above and other aspects, features, and advantages of certain embodiments will be more apparent from the following description taken in conjunction with the accompanying drawings, in which:

FIG. 1 illustrates a structure of a wireless network according to an embodiment of the present application;

FIG. 2A illustrates a transmission path according to an embodiment of the present application;

FIG. 2B illustrates a reception path according to an embodiment of the present application;

FIG. 3A illustrates a UE according to an embodiment of the present application;

FIG. 3B illustrates a BS according to an embodiment of the present application;

FIG. 4 illustrates a method performed by a UE according to an embodiment of the present application;

FIG. 5 illustrates a method of performing resource mapping according to an embodiment of the present application;

FIG. 6 illustrates another method of performing resource mapping according to an embodiment of the present application;

FIG. 7 illustrates still another method of performing resource mapping according to an embodiment of the present application;

FIG. 8 illustrates a time domain resource allocation method according to an embodiment of the present application;

FIG. 9 illustrates another time domain resource allocation method according to an embodiment of the present application;

FIG. 10 illustrates a method performed by a BS according to an embodiment of the present application; and

FIG. 11 illustrates an electronic device according to an embodiment of the present application.

### DETAILED DESCRIPTION

The following description with reference to the accompanying drawings is provided to assist in a comprehensive understanding of embodiments of the disclosure s. It includes various specific details to assist in that understanding but these are to be regarded as merely exemplary. Accordingly, those of ordinary skill in the art will recognize that various changes and modifications of the embodiments described herein can be made without departing from the scope and spirit of the disclosure. Descriptions of well-known functions and constructions may be omitted for the sake of clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description is provided for illustration purpose only and not for the purpose of limiting the disclosure. It is to be understood that the singular forms a, an, and the include plural referents unless the context clearly dictates otherwise. Thus, reference to a component surface includes reference to one or more of such surfaces.

The term include or may include refers to the existence of a corresponding disclosed function, operation or component which can be used herein and does not limit one or more additional functions, operations, or components. The terms such as include and/or have may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term or used herein includes any or all of combinations of listed terms. For example, the expression A or B may include A, may include B, or may include both A and B.

Unless defined differently, all terms used in the disclosure, which include technical terminologies or scientific terminologies, have the same meaning as understood by one skilled in the art. Such terms as those defined in a generally used dictionary are to be interpreted to have the meanings equal to the contextual meanings in the relevant field of art, and are not to be interpreted to have ideal or excessively formal meanings unless clearly defined in the disclosure.

The terms “first”, “second”, “third”, “fourth”, “1”, “2”, etc. (if any) in the specification and claims of the disclosure and the accompanying drawings are used for distinguishing similar objects, rather than describing a particular order or precedence. It is to be understood that the data so used are interchangeable in the appropriate cases, such that the embodiments of the disclosure described herein may be implemented in orders other than those illustrated herein.

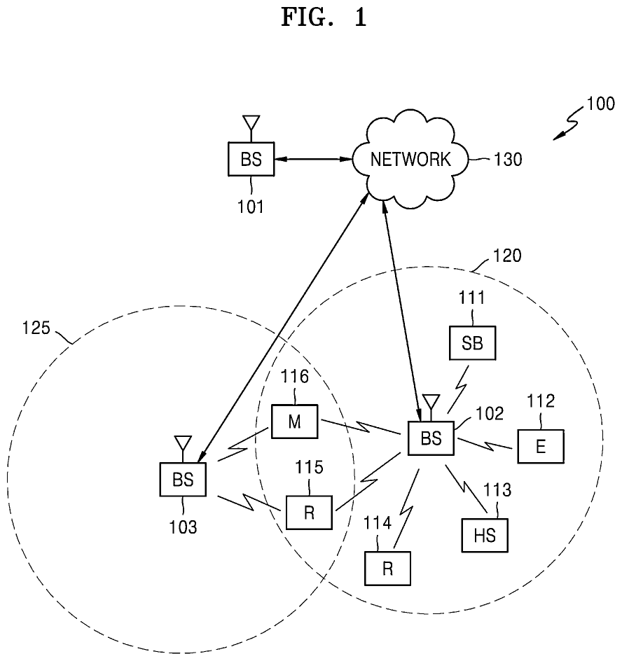

FIG. 1 illustrates a wireless network 100 according to an embodiment of the present application.

Referring to FIG. 1, the wireless network 100 includes a gNodeB (gNB) 101, a gNB 102, and a gNB 103. The gNB 101 communicates with gNB 102 and gNB 103 and also communicates with at least one Internet protocol (IP) network 130, such as the Internet, a private IP network, or other data networks.

Depending on a type of the network, other well-known terms such as BS or access point can be used instead of gNodeB or gNB. For convenience, the terms gNodeB and gNB are used in this patent document to refer to network infrastructure components that provide wireless access for remote terminals. And, depending on the type of the network, other well-known terms such as mobile station, user station, remote terminal, wireless terminal or user apparatus can be used instead of UE or UE. For convenience, the terms UE and UE are used in this patent document to refer to remote wireless devices that wirelessly access the gNB, no matter whether the UE is a mobile device (such as a mobile phone or a smart phone) or a fixed device (such as a desktop computer or a vending machine).

The gNB 102 provides wireless broadband access to the network 130 for a first plurality of UEs within a coverage area 120 of gNB 102. The first plurality of UEs include a UE 111, which may be located in a small business (SB), a UE 112, which may be located in an enterprise (E), a UE 113, which may be located in a wireless fidelity (WiFi) hotspot (HS), a UE 114, which may be located in a first residence (R), a UE 115, which may be located in a second residence (R), a UE 116, which may be a mobile device (M), such as a cellular phone, a wireless laptop computer, a wireless PDA, etc. The gNB 103 provides wireless broadband access to network 130 for a second plurality of UEs within a coverage area 125 of gNB 103. The second plurality of UEs include a UE 115 and a UE 116. One or more of gNBs 101-103 can communicate with each other and with UEs 111-116 using 5G, LTE, LTE-advanced (LTE-A), WiMAX or other advanced wireless communication technologies.

The dashed lines show approximate ranges of the coverage areas 120 and 125, and the ranges are shown as approximate circles merely for illustration and explanation purposes. The coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a two-dimensional (2D) antenna array as described herein. One or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

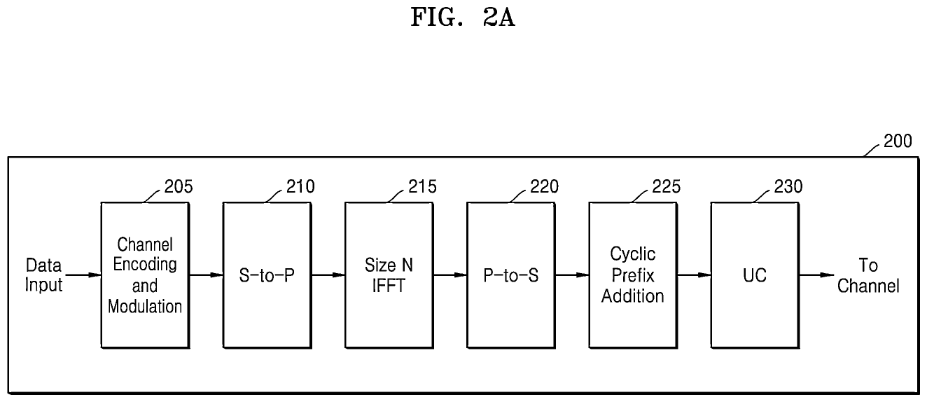

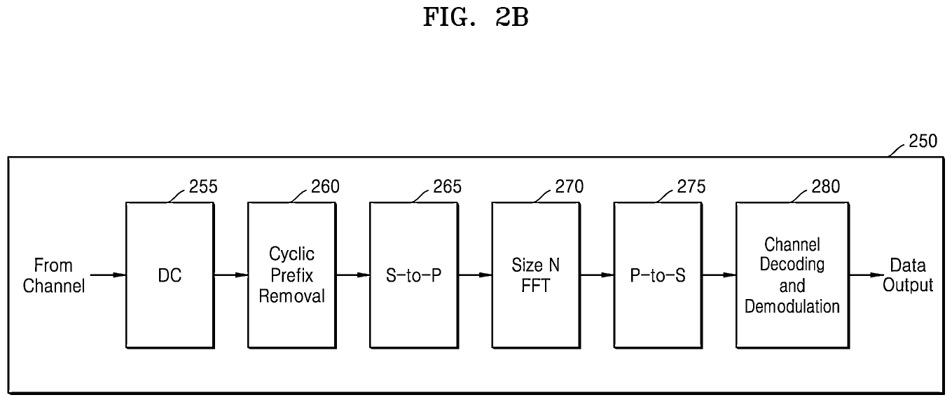

FIG. 2A illustrates a transmission path according to an embodiment of the present application.

FIG. 2B illustrates a reception path according to an embodiment of the present application.

The transmission path 200 in FIG. 2A can be described as being implemented in gNB 102, and the reception path 250 in FIG. 2B can be described as being implemented in UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the disclosure.

Referring to FIG. 2A, the transmission path 200 includes a channel coding and modulation block 205, a Serial-to-Parallel (S-to-P) block 210, a size N inverse fast Fourier transform (IFFT) block 215, a Parallel-to-Serial (P-to-S) block 220, a cyclic prefix (CP) addition block 225, and an up-converter (UC) 230.

Referring to FIG. 2B, the reception path 250 includes a down-converter (DC) 255, a CP removal block 260, an S-to-P block 265, a size N fast Fourier transform (FFT) block 270, a P-to-S block 275, and a channel decoding and demodulation block 280.

In the transmission path 200, the channel coding and modulation block 205 receives a set of information bits, applies coding (such as low density parity check (LDPC) coding), and modulates the input bits (such as using quadrature phase shift keying (QPSK) or quadrature amplitude modulation (QAM)) to generate a sequence of frequency-domain modulated symbols. The S-to-P block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The P-to-S block 220 multiplexes parallel time-domain output symbols from the Size N IFFT block 215 to generate a serial time-domain signal. The cyclic prefix addition block 225 inserts a CP into the time-domain signal. The up-converter 230 up-converts the output of the CP addition block 225 to an RF frequency for transmission via a wireless channel. The signal can also be filtered at a baseband before converting to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the CP removal block 260 removes the cyclic prefix to generate a serial time-domain baseband signal. The S-to-P block 265 converts the time-domain baseband signal into a parallel time-domain signal. The Size N FFT block 270 performs an FFT algorithm to generate N parallel frequency-domain signals. The P-to-S block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the DL and may implement a reception path 250 similar to that for receiving from UEs 111-116 in the UL. Similarly, each of UEs 111-116 may implement a transmission path 200 for transmitting to gNBs 101-103 in the UL, and may implement a reception path 250 for receiving from gNBs 101-103 in the DL.

Each of the components in FIGS. 2A and 2B can be implemented using only hardware or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Although described as using FFT and IFFT, this is only illustrative and should not be interpreted as limiting the scope of the disclosure. Other types of transforms can be used, such as discrete Fourier transform (DFT) and inverse DFT (IDFT) functions. For DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. FIGS. 2A and 2B are intended to illustrate examples of types of transmission and reception paths that can be used in a wireless network. Any other suitable architecture can be used to support wireless communication in a wireless network.

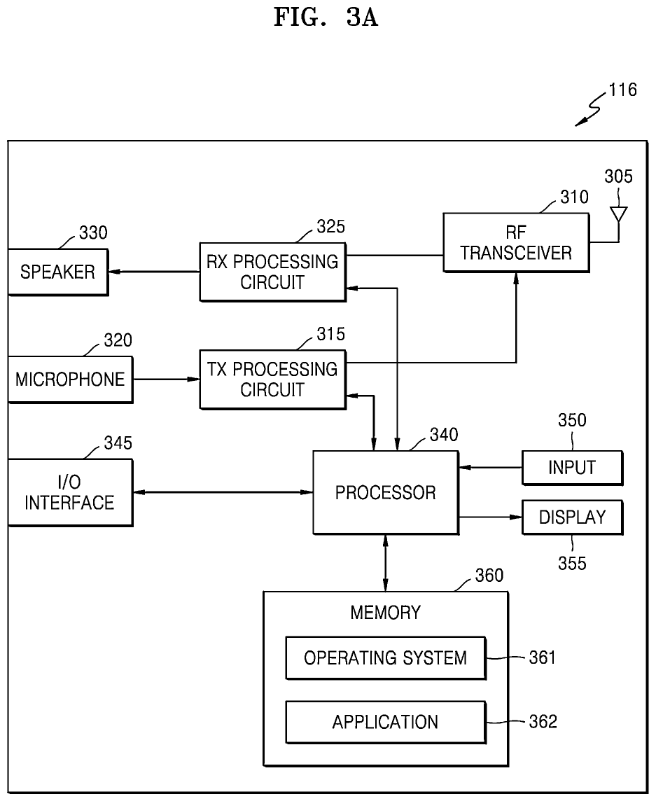

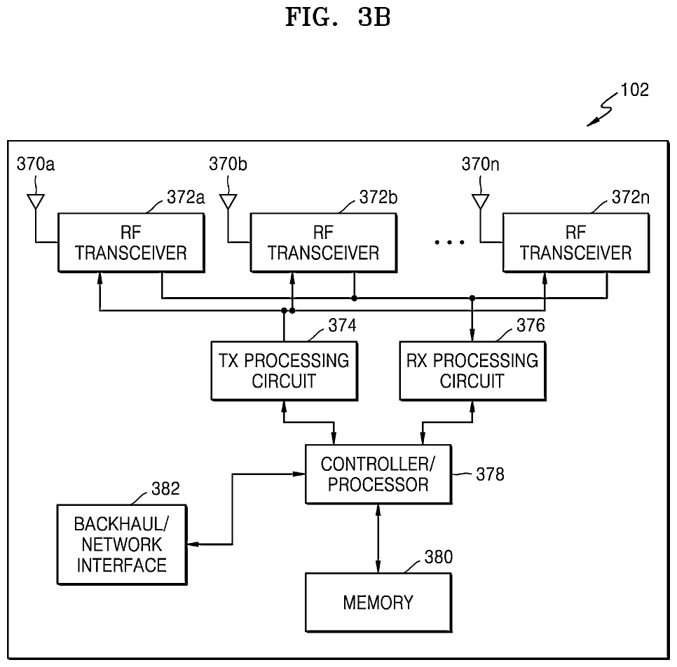

FIG. 3A illustrates a UE 116 according to an embodiment of the present application. However, UE 116 is for illustration only, and UEs 111-115 of FIG. 1 can have the same or similar configuration.

Referring to FIG. 3A, the UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal which is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described herein. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of the UE 116 can input data into the UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Various changes can be made to FIG. 3A. For example, various components in FIG. 3A can be combined, further subdivided or omitted, and additional components according to specific requirements. For example, the can be added processor/controller 340 can be divided into a plurality of processors, such as one or more central processing units (CPUs) and one or more graphics processing units (GPUs). Although FIG. 3A illustrates that the UE 116 is configured as a mobile phone or a smart phone, UEs can be configured to operate as other types of mobile or stationary devices.

FIG. 3B illustrates a gNB 102 according to an embodiment of the present application. However, gNB 102 is for illustration only, and other gNBs of FIG. 1 can have the same or similar configuration.

Referring to FIG. 3B, gNB 102 includes a plurality of antennas 370a-370n, a plurality of RF transceivers 372a-372n, a TX processing circuit 374, and an RX processing circuit 376. One or more of the plurality of antennas 370a-370n includes a 2D antenna array. gNB 102 also includes a controller/processor 378, a memory 380, and a backhaul or network interface 382.

The RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. The RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a blind interference sensing (BIS) process such as that performed through a BIS algorithm and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 enables the gNB 102 to communicate with other devices or systems through a backhaul connection or through a network. The backhaul or network interface 382 can support communication over any suitable wired or wireless connection(s). For example, when the gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When the gNB 102 is implemented as an access point, the backhaul or network interface 382 can enable the gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. A plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

The TX and RX paths of gNB 102 (implemented using RF transceivers 372a-372n, TX processing circuit 374 and/or RX processing circuit 376) support aggregated communication with frequency division duplex (FDD) and time division duplex (TDD) cells.

Although FIG. 3B illustrates an example of gNB 102, various changes may be made to FIG. 3B. For example, gNB 102 can include any number of each component shown in FIG. 3A. The access point can include many backhaul or network interfaces 382, and the controller/processor 378 can support routing functions to route data between different network addresses. Although shown as including a single instance of the TX processing circuit 374 and a single instance of the RX processing circuit 376, gNB 102 can include multiple instances of each (such as one for each RF transceiver).

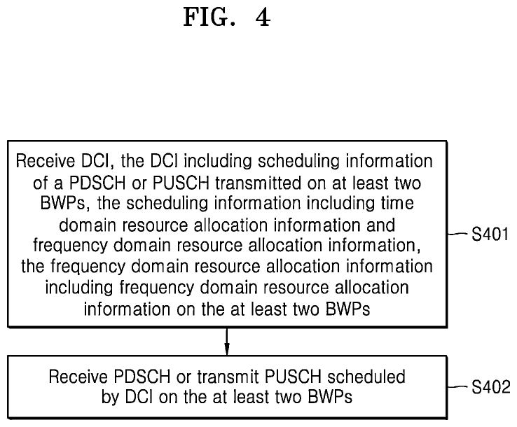

FIG. 4 illustrates a method performed by a UE in a communication system according to an embodiment.

Referring to FIG. 4, in step S401, DL control information (DCI) is received, the DCI including scheduling information of a PDSCH or PUSCH transmitted at least two bandwidth parts (BWPs), the scheduling information including time domain resource allocation information and frequency domain resource allocation information, wherein the frequency domain resource allocation information includes frequency domain resource allocation information on the at least two BWPs.

In step S402, the transmission of a PDSCH or PUSCH scheduled by the DCI is performed on the at least two BWPs.

The frequency domain resources included in each of the at least two BWPs do not overlap.

The at least two BWPs are located on different carriers, respectively.

The at least two BWPs are located in different frequency bands, respectively.

The carriers where the at least two BWPs are located respectively are configured in a same serving cell.

If the operator has more spectrum resources, the rate of the terminal can be improved by deploying a plurality of carriers.

In FIG. 4, the multi-carrier configuration in one serving cell becomes possible. Compared with the conventional aggregation of a plurality of carriers by aggregating a plurality of serving cells, the aggregation of a plurality of carriers by aggregating at least two BWPs in one serving cell is more flexible, and can simplify the system and reduce signaling overhead in the following manners.

Specifically, compared with the aggregation of a plurality of carriers by aggregating a plurality of serving cells, the aggregation of a plurality of carriers by aggregating at least two BWPs in one serving cell has at least one of the following advantages:

First, the broadcast signaling overhead is saved. For example, in the CA system, each carrier corresponds to one serving cell, and it is needed to transmit on each carrier the broadcast signaling such as an SSB and a system information block 1 (SIB1) of the corresponding serving cell. For the system where a plurality of carriers are configured in one serving cell provided in the embodiment of the disclosure, it is only necessary to transmit the broadcast signaling of the serving cell on one of the carriers.

Second, the signaling for carrier activation is simplified. For example, in the CA system, a secondary cell can be activated/deactivated through a radio resource control (RRC) or medium access control (MAC) control element (CE) signaling, and the activation/deactivation of the secondary cell can also be interpreted as the activation/deactivation of the carrier corresponding to the secondary cell. For the system where a plurality of carriers are configured in one serving cell provided in the embodiment of the disclosure, a plurality of BWPs in one serving cell can be activated/deactivated through a physical layer signaling, wherein the plurality of activated BWPs are located on different carriers, respectively. The activation/deactivation of a plurality of BWPs can also be interpreted as the activation/deactivation of the carriers where the BWPs are located.

Third, mobility measurement and management are simplified. For example, in the CA system, each carrier corresponds to one serving cell, and the mobility measurement and management of the corresponding serving cell need to be performed on each carrier. For the system where a plurality of carriers are configured in one serving cell provided in the embodiment of the disclosure, it is only necessary to perform the mobility measurement and management of the serving cell on one of the carriers (e.g., an anchor carrier or a preconfigured carrier, but not limited thereto).

It can be known from the above analysis that, compared with CA/DC, the configuration of a plurality of carriers in one serving cell is more flexible and can simplify the system and reduce signaling overhead.

In addition, in the existing 5G new radio (NR) communication system, one DL carrier and at most two UL carriers may be configured in one serving cell. When two UL carriers are configured in one serving cell, one UL carrier is referred to as a normal UL (NUL), and the other UL carrier is referred to as a supplement UL (SUL). The SUL is generally located in a lower frequency band and used for enhancing the coverage range of the UL, and the SUL configuration is optional. Although the SUL and the NUL belong to a same serving cell, that is, a plurality of UL carriers are configured in one serving cell, the UE can dynamically switch UL transmission in the SUL and the NUL, but cannot perform UL transmission simultaneously on both the SUL and the NUL. Thus, the SUL can only improve the coverage of the UL but cannot improve the peak rate of the UL transmission.

Herein, a plurality of DL carriers and more than two UL carriers are configured in one serving cell. In addition, deploying a plurality of carriers in one serving cell as disclosed herein differs from doing so in the SUL since a PDSCH or a PUSCH can be jointly transmitted on a plurality of carriers in one serving cell. That is, a transport block (TB) can be transmitted across a plurality of carriers in one serving cell, so that a frequency diversity gain is obtained and the peak rate is improved.

The description is provided for transmitting a TB across a plurality of carriers.

The time unit may be an orthogonal frequency division multiplexing (OFDM) symbol or a single-carrier-FDMA (SC-FDMA) symbol, or the time unit is a slot.

The BWP is essentially a segment of consecutive frequency domain resources, and the BWP may be replaced by other terms having the same meaning. For example, the BWP may be replaced by subband.

The serving cell may also be referred to as a cell.

A plurality of carriers may be configured in a serving cell, one of the carriers may be referred to as an anchor carrier, and other carriers are referred as non-anchor carriers. For example, the carrier for transmitting cell system information is referred to as an anchor carrier, and other carriers are referred to as non-anchor carriers. The BS transmits a synchronization signal (SS) and a cell defining SSB (CD-SSB) and cell system information on the anchor carrier, wherein the cell system information includes SIB1 and other SIBs. The BS configures the information of other non-anchor carriers through the anchor carrier. When the anchor carrier is a TDD carrier, an anchor DL carrier and an anchor UL carrier are identical anchor carrier; and, when the anchor carrier is an FDD carrier, the anchor carrier includes an anchor DL carrier and its paired anchor UL carrier. On the anchor DL carrier, an initial DL BWP is configured. On the anchor UL carrier, a physical random access channel (PRACH) resource pool for accessing the network and an initial UL BWP are configured. Based on the PRACH configuration parameter, the UE may access the network through the anchor carrier. In other words, the anchor carrier is a carrier with functionalities of the cell system information transmission and/or initial access.

A plurality of carriers may be configured in one serving cell, and one or more BWPs may be configured on each carrier. The UE can perform simultaneous transmission on the BWPs of the plurality of carriers, so as to obtain a bandwidth gain to greatly improve the peak rate and achieve the effects similar to CA. The corresponding implementation may be activating a plurality of BWPs, where the plural activated BWPs belong to different carriers. Alternatively, the UE can dynamically switch transmission on the plurality of carriers to obtain a diversity gain. The corresponding implementation may be supporting the cross-carrier BWP switch.

When a plurality of BWPs on different carriers is activated in a serving cell, the UE may perform simultaneous transmission on the plurality of activated BWPs. In one transmission mode for a plurality of activated BWPs, the UE transmits different TBs on a plurality of activated BWPs, respectively, i.e., transmitting different PDSCHs or different PUSCHs on a plurality of activated BWPs, respectively. For example, N different TBs are transmitted on N activated BWPs, and the transmissions of the N different TBs may be scheduled by one DCI or N DCIs. An other transmission mode for a plurality of activated BWPs is that the UE transmits a same TB on a plurality of activated BWPs, i.e., transmitting a PDSCH or PUSCH on a plurality of activated BWPs. For example, one TB is transmitted on N activated BWPs, and the transmission of the TB across N BWPs is scheduled by one DCI, where N is a positive integer greater than 1.

When a plurality of BWPs are activated, according to different functions of the activated BWPs, one activated BWP in the plurality of activated BWPs is referred to as a first BWP, and other activated BWPs are referred to as second BWPs. That is, the activated BWPs on at least two different carriers in one serving cell include one first BWP and at least one second BWP. The first BWP may also be referred to as a first activated BWP, a primary BWP or a primary activated BWP, and the second BWP may also be referred to as a second activated BWP, a secondary (supplementary) BWP or a secondary (supplementary) activated BWP.

The primary activated BWP (i.e., the first BWP) may be defined by at least one of the following methods:
(1) The primary activated BWP has a complete BWP configuration by reusing the existing BWP configuration, so that it can be scheduled and used independently. The secondary activated BWP has only the bandwidth related configuration, but has no configurations related to any physical channel or signal transmission, so the secondary activated BWP cannot be scheduled and used independently and can only be used in conjunction with the primary activated BWP to realize the bandwidth expansion function.
(2) The control channel transmission can be configured on the primary activated BWP, while the control channel transmission cannot be configured on the secondary activated BWP. For example, physical DL control channel (PDCCH) and/or physical UL control channel (PUCCH) transmission can be configured on the primary activated BWP, while the PDCCH and PUCCH transmission cannot be configured on the secondary activated BWP. Since the control channel transmission is configured on the primary activated BWP, the primary activated BWP cannot be deactivated, but the secondary activated BWP can be deactivated.

Thus, at least two activated BWPs on different carriers in one serving cell includes at least one of the following situations:
the first BWP and the second BWP share a configuration of the PDSCH and/or PUSCH; and
the first BWP and the second BWP share a configuration of a first parameter of the PDSCH and/or PUSCH, and a second parameter other than the first parameter is configured for the first BWP and the second BWP, respectively. In other words, the first BWP and the second BWP share partially the same configuration of the PDSCH and/or PUSCH.

The first BWP includes at least one of the following: the first BWP is a BWP on an anchor carrier; the first BWP is a BWP on a carrier with an index of 0; the first BWP is a BWP on a carrier with the smallest index, the first BWP is a BWP on a carrier with the lowest frequency, and the first BWP is a BWP configured through a high layer signaling.

The first BWP is used to transmit a physical control channel (including a PDCCH and/or a PUCCH) and a physical shared channel (including a PDSCH and/or a PUSCH), and the second BWP is used to transmit a physical shared channel.

To reduce the power consumption of the UE in monitoring the PDCCH, the network may configure the PDCCH transmission on only one BWP in the at least two BWPs. That is, the UE monitors the PDCCH on only one BWP in the at least two BWPs. Specifically, in step S401 in FIG. 4, the UE may monitor the PDCCH on a first preset BWP of the at least two BWPs, and the PDCCH includes scheduling information related to the at least two BWPs, wherein the first preset BWP is the first BWP, or the first preset BWP is configured as one of the at least two BWPs.

To reduce the resource for the configuration of the PUCCH, the network may configure the PUCCH on only one BWP in the at least two BWPs, that is, the UE transmits the PUCCH on only one BWP of the at least two BWPs. Specifically, in step S401 in FIG. 4, the UE may transmit the PUCCH on a second preset BWP of the at least two BWPs, and the PUCCH includes UL control information related to the at least two BWPs, wherein the second preset BWP is the first BWP, or the second preset BWP is configured as one of the at least two BWPs.

Furthermore, step S402 in FIG. 4 may include performing the repetitive reception or transmission of the PDSCH or PUSCH scheduled by the DCI, on the at least two BWPs, respectively.

A plurality of carriers are configured in one serving cell, and one TB (one PDSCH or one PUSCH) can be transmitted across a plurality of carriers in the cell, such that resources are allocated on the plurality of carriers to transmit a same TB. The transmission signal on each carrier can be regarded as a different repetition of the same TB, and each repetition can use a same or different redundancy version (RV).

For example, in step S401, the UE monitors a DCI. The DCI is used to schedule a PDSCH or PUSCH transmitted across a plurality of BWPs (i.e., across a plurality of carriers), and the DCI includes time domain resource allocation information and frequency domain resource allocation information on the plurality of BWPs.

In step S402, for the PDSCH, the UE receives different repetitive transmissions of the same TB on the plurality of BWPs (i.e., the plurality of carriers), respectively; while for the PUSCH, the UE transmits different repetitive transmissions of the same TB on the plurality of BWPs (i.e., the plurality of carriers), respectively.

By using a PDSCH as an example, the repetition-based transmission mode means that the time/frequency domain resource allocated on each carrier is used to transmit one repetition of the PDSCH, i.e., corresponding to one RV, and N carriers correspond to N repetitive transmissions of the PDSCH. Each repetition of the PDSCH may be decoded independently, and the UE may try to decode each repetition of the PDSCH, respectively. Alternatively, a plurality of repetitions of the PDSCH may be softly merged and then decoded, and the plurality of repetitive transmission may use the same or different RVs. In this transmission mode, the UE performs rate matching on the repetitive transmission on each activated BWP, respectively.

In the current communication system, the TB size (TBS) is determined based on the number of resource elements (REs). For example, the UE first determines the number N_{RE} of REs, then determines an unquantified intermediate variable N_{info} based on the number N_{RE}, determines a quantified intermediate variable N_{info}′ according to the value range of the unquantified intermediate variable N_{info}, and searches a TBS value that is greater than or equal to and closest to N_{info}′ from a TBS table as the determined TBS.

When performing the repetitive reception or transmission of the PDSCH or PUSCH scheduled by the DCI on the at least two BWPs, respectively, the first TBS of the PDSCH or PUSCH transmitted on the at least two BWPs may also be determined based on at least one of the following:

### Method 1: The Average Number of REs Determined Based on the at Least Two BWPs.

That is, for the first step (i.e., determining the number of REs) of the above TBS determination process, the average number of REs on a plurality of BWPs may be used as the number N_{RE} of REs for determining the first TBS.

The number of PRBs allocated on different BWPs may be different, the number of symbols allocated on different BWPs may also be different, the demodulation reference signal (DMRS) patterns used on different BWPs may also be different (that is, the number of DMRS REs of each PRB on different BWPs may also be different), and the magnitudes of the signaling overheads Nₒₕ^{PRB} configured on different BWPs may also be different. The UE needs to respectively determine the number N_{RE,i} of REs on each BWP and then divide the total number of REs on all BWPs by the number of BWPs to obtain the average number of REs, that is, N_{RE}=┌(Σᵢ₌₀^{i=N-1} N_{RE,i})/N┐ or N_{RE}=└(Σᵢ₌₀^{i=N-1} N_{RE,i})/N┘, where N is the number of activated BWPs (possibly the number of carriers) that transmit one TB, and N_{RE,i} is the number of REs on the ith activated BWP (or the ith carrier). During the determination of N_{RE,i}, the UE first determines the number N_{RE,i}′ of REs in one PRB on the ith activated BWP (or the ith carrier), N_{RE,i}′=N_{sc}^{RB}·N_{symb,i}^{sh}−−N_{DMRS,i}^{PRB}−N_{oh,i}^{PRB}, and then determine the number of RES on the ith activated BWP (or the ith carrier) based on N_{RE,i}=min (156, N_{RE,i}′)*n_{PRB,i}, where n_{PRB,i} is the number of PRBs allocated on the ith activated BWP (or the ith carrier); N_{sc}^{RB} is the number of REs included in one PRB, e.g., N_{sc}^{RB}=12; N_{symb,i}^{sh} is the number of PDSCH symbols allocated in a slot on the ith activated BWP (or the ith carrier); N_{DMRS,i}^{PRB} is the number of REs used for DMRS in each PRB on the ith activated BWP (or the ith carrier); and, N_{oh,i}^{PRB} is the magnitude of the signaling overhead on the ith activated BWP (or the ith carrier) configured through the high layer parameter.

The number of PRBs allocated on different BWPs may be different, but the number of symbols allocated on the different BWPs is the same, the DMRS patterns used on different BWPs are also the same (that is, the number of DMRS REs of each PRB on different BWPs is also the same), and the magnitudes of the signaling overheads Nₒₕ^{PRB} on different BWPs are also the same. The UE first determines the number of REs in a PRB based on N_{RE}′=N_{sc}^{RB}·N_{symb}^{sh}−N_{DMRS}^{PRB}−Nₒₕ^{PRB}, then determines the average number of PRBs allocated on all BWPs by dividing the total number of PRBs allocated on all BWPs by the number of BWPs to obtain the average number of PRBs, that is, n_{PRB}=┌(Σᵢ₌₀^{i=N-1}n_{PRB,i})/N┐ or n_{PRB}=└(Σᵢ₌₀^{i=N-1}n_{PRB,i})/N┘, and determines the number of REs based on N_{RE}=min (156, N_{RE}′)*n_{PRB}, where N is the number of activated BWPs (i.e., the number of carriers) that transmit one TB; N_{sc}^{RB} is the number of REs included in a PRB, e.g., N_{sc}^{RB}=12; N_{symb}^{sh} is the number of PDSCH symbols allocated in a slot; N_{DMRS}^{PRB} is the number of REs used for DMRS in each PRB; Nₒₕ^{PRB} is the magnitude of the signaling overhead configured through the high layer parameter; and, N_{PRB,i} is the number of PRBs allocated in the ith activated BWP (or the ith carrier).
Method 2: the maximum value among the numbers of REs respectively determined based on the at least two BWPs.

That is, for the first step (i.e., determining the number of REs) of the above TBS determination process, the maximum number of REs determined based on a plurality of BWPs may be used as the number N_{RE} of REs for determining the first TBS.

The number of PRBs allocated on different BWPs may be different, the numbers of symbols allocated on different BWPs may also be different, the DMRS patterns used on different BWPs may also be different (that is, the number of DMRS REs of each PRB on different BWPs may also be different), and the magnitudes of the signaling overheads Nₒₕ^{PRB} configured on different BWPs may also be different. The UE needs to respectively determine the number N_{RE,i} of REs on each BWP, and then use the maximum value (i.e., the maximum number of REs) as the number N_{RE} of REs for determining the first TBS, i.e., N_{RE}=max (N_{RE,i}′).

The number of PRBs allocated on different BWPs may be different, but the number of symbols allocated on the different BWPs is the same, the DMRS patterns used on different BWPs are also the same (that is, the number of DMRS REs of each PRB on different BWPs is also the same), and the magnitudes of the signaling overheads on different BWPs are also the same. The UE first determines the number of REs in a PRB based on N_{RE}′=N_{sc}^{RB}·N_{symb}^{sh}−N_{DMRS}^{PRB}−Nₒₕ^{PRB}, and then determines the maximum number n_{PRB} of PRBs allocated on all BWPs, that is, n_{PRB}=max (n_{PRB,i}), where n_{PRB,i} is the number of PRBs allocated on the ith activated BWP (or the ith carrier); N_{sc}^{RB} is the number of REs included in a PRB, e.g., N_{sc}^{RB}=12; N_{symb}^{sh} is the number of PDSCH symbols allocated in a slot; N_{DMRS}^{PRB} is the number of REs used for DMRS in each PRB; and, Nₒₕ^{PRB} is the magnitude of the signaling overhead configured through the high layer parameter. Then, the number of REs is determined based on N_{RE}=min (156, N_{RE}′)*n_{PRB}.
Method 3: the minimum value of the number of REs respectively determined based on the at least two BWPs.

That is, for the first step (i.e., determining the number of REs) of the above TBS determination process, the minimum number of REs determined based on a plurality of BWPs may be used as the number N_{RE} of REs for determining the first TBS.

The number of PRBs allocated on different BWPs may be different, the number of symbols allocated on different BWPs may also be different, the DMRS patterns used on different BWPs may also be different (that is, the number of DMRS REs of each PRB on different BWPs may also be different), and the magnitudes of the signaling overheads Nₒₕ^{PRB} configured on different BWPs may also be different. The UE needs to respectively determine the number N_{RE,i} of REs on each BWP, and then use the minimum value (i.e., the minimum number of REs) as the number N_{RE} of RES for determining the first TBS, that is, N_{RE}=min (N_{RE,i}).

The number of PRBs allocated on different BWPs may be different, but the number of symbols allocated on the different BWPs is the same, the DMRS patterns used on different BWPs are also the same (that is, the number of DMRS REs of each PRB on different BWPs is also the same), and the magnitudes of the signaling overheads Nₒₕ^{PRB} on different BWPs are also the same. The UE first determines the number of REs in a PRB based on N_{RE}′=N_{sc}^{RB}·N_{symb}^{sh}−N_{DMRS}^{PRB}−Nₒₕ^{PRB}, and then determines the minimum number n_{PRB} of PRBs allocated on all BWPs, that is, n_{PRB}=min (n_{PRB,i}), where n_{PRB,i} is the number of PRBs allocated on the ith activated BWP (or the ith carrier), N_{sc}^{RB} is the number of REs included in a PRB, e.g., N_{sc}^{RB}=12, N_{symb}^{sh} is the number of PDSCH symbols allocated in a slot, N_{DMRS}^{PRB} is the number of REs used for DMRS in each PRB, and Nₒₕ^{PRB} is the magnitude of the signaling overhead configured through the high layer parameter. Then, the number of REs is determined based on N_{RE}=min (156, N_{RE}′)*n_{PRB}.
Method 4: the number of REs determined based on a preset BWP of the at least two BWPs.

That is, for the first step (i.e., determining the number of REs) of the above TBS determination process, the number of REs determined based on a particular BWP (or a particular carrier) may be used as the number N_{RE} of REs for determining the first TBS. The particular BWP may be a primary activated BWP (i.e., the first BWP), an activated BWP with the smallest index, an activated BWP on an anchor carrier, an activated BWP on a carrier with an index of #0, an activated BWP on a carrier with the smallest index in a plurality of carriers, an activated BWP on a carrier with the lowest frequency, or an activated BWP configured through a signaling, etc., but the disclosure is not limited thereto. The activated BWP configured through a signaling may be configured through a high layer signaling, or indicated by the DCI scheduling transmission across multiple activated BWPs.
Method 5: a scaling factor corresponding to the first TBS.

For the step (i.e., determining the number of REs) of the above TBS determination process, the UE may use the value obtained by multiplying the number of REs determined by the above method 1, 2, 3 or 4 by a scaling factor as the number N_{RE} of REs for determining the first TBS. For example, N_{RE}=┌N_{RE}′*f₁┐ or N_{RE}=└N_{RE}′*f₁┘, wherein the magnitude of the scaling factor f₁ may be configured through a high layer signaling, and N_{RE} is the number of REs determined by method 1, 2, 3 or 4. Different activated BWPs may be configured with different scaling factors f₁.

Alternatively, the UE may use the value obtained by multiplying the TBS determined by the above method 1, 2, 3 or 4 by a scaling factor as the TBS. For example, TBS=┌TBS′*f₂┐ or TBS=└TBS′*f₂┘, wherein the magnitude of the scaling factor f₂ may be configured through a high layer signaling, and TBS' is the TBS value determined by the above methods. Different activated BWPs may be configured with different scaling factors f₂.

When performing the repetitive reception or transmission of the PDSCH or PUSCH scheduled by the DCI on the at least two BWPs, respectively, the RVs of the PDSCH or PUSCH on the at least two BWPs may also be determined in at least one of the following manners:
Method 6: The RVs of the PDSCH or PUSCH on the at least two BWPs are identical. For example, the PDSCH repetition on each activated BWP uses the same RV. This RV may be predefined, configured through a high layer signaling, or indicated through the scheduling DCI.
Method 7: The RV of the PDSCH or PUSCH on each BWP in the at least two BWPs is different. For example, the PDSCH repetition on each activated BWP may use a different RV, and the RV of the PDSCH repetition on each activated BWP may be separately predefined, or separately configured through a high layer signaling, or separately indicated through the scheduling DCI.
Method 8: The RV transmitted on each BWP in the at least two BWPs is different, each RV is determined by an RV order, and each BWP in the at least two BWPs cyclically corresponds to each TV in the RV order successively. For example, the RV of the PDSCH repetition on each activated BWP is determined based on the preset RV order (or referred to as an RV turning order). When making each activated BWP correspond to the RV order, a plurality of activated BWPs may be arranged from low frequency to high frequency, or a plurality of activated BWPs may be arranged from a low to high index of the carriers, or a low to high index of the BWPs (assuming that the BWPs on all carriers are numbered with indexes together), and so on. Other arrangement modes are also possible. The RV order is predefined, or configured through a high layer signaling. The RV order is {#0, #1, #2, #3} or {#0, #2, #3, #1}, but the disclosure is not limited thereto.
Method 9: The RV of the PDSCH or PUSCH on each BWP in the at least two BWPs is different, each RV is determined by an RV order and a starting RV, and each BWP in the at least two BWPs cyclically corresponds to each RV in the RV order successively from the starting RV. For example, the RV of the PDSCH repetition on each activated BWP is determined based on the preset RV order (or referred to as an RV turning order) and the starting RV, wherein the RV order is predefined or configured through a high layer signaling, and the starting RV is predefined, configured through a high layer signaling or indicated through the DCI. The arrangement mode of making each activated BWP correspond to the RV, the optional RV order and the like are described above in method 7 and will not be repeated here.

When it is assumed that the RV turning order is {#0, #3, #2, #1}, there is a total of three activated BWPs and the starting RV is #3, the RVs corresponding to the PDSCH repetitions on the three activated BWPs are #3, #2 and #1, respectively. The starting RV corresponding to the first activated BWP may be fixed. For example, the starting RV is predefined or preconfigured through a high layer signaling. Alternatively, the starting RV corresponding to the first activated BWP may be dynamically changed. For example, the starting RV is indicated through the scheduling DCI.

The above description of the implementation based on the transmission of a PDSCH across multiple carriers is also applicable to the transmission of a PUSCH across multiple carriers, and the similar implementation process will not be repeated.

Alternatively in step S402 of FIG. 4. it is possible to perform the segmented reception or transmission of the PDSCH or PUSCH scheduled by the DCI on the at least two BWPs, respectively.

A plurality of carriers is configured in one serving cell, and one TB may be transmitted across a plurality of carriers in the cell. That is, resources are allocated on a plurality of carriers to transmit this TB. The transmission signal on each carrier may be regarded as a different segment of the same TB. In other words, rate matching is based on the mapping of all resources allocated on the plurality of carriers, and the encoded and modulated signal of one TB is mapped to different carriers in segments.

Alternatively in step S401, a DCI is obtained by the UE. The DCI is used to schedule a PDSCH or PUSCH transmitted across a plurality of BWPs (i.e., across a plurality of carriers), and the DCI includes time domain resource allocation information and frequency domain resource allocation information on the plurality of BWPs.

Alternatively in step S402, for the PDSCH, different segmented transmissions of a same TB on the plurality of BWPs (i.e., the plurality of carriers) are received by the UE, respectively; while for the PUSCH, the UE transmits different segmented transmissions of a same TB on the plurality of BWPs (i.e., the plurality of carriers), respectively.

By using a PDSCH as an example, the segment based transmission mode means that some signals of the PDSCH are transmitted on the time/frequency domain resource allocated on each carrier. That is, the transmission signal of the PDSCH is divided into N segments, and the N segments are mapped to the time/frequency domain resources of N carriers, respectively. The transmission signal on each carrier cannot be independently decoded, and the transmission signals on all carriers can be decoded only after being cascaded. That is, the encoded and modulated signal of the TB of the PDSCH is mapped to different carries in segments.

When performing the segmented reception or transmission of the PDSCH or PUSCH scheduled by the DCI on the at least two BWPs, respectively, the process of mapping the PDSCH or PUSCH scheduled by the DCI to the physical resource may be executed in at least one of the following manners.

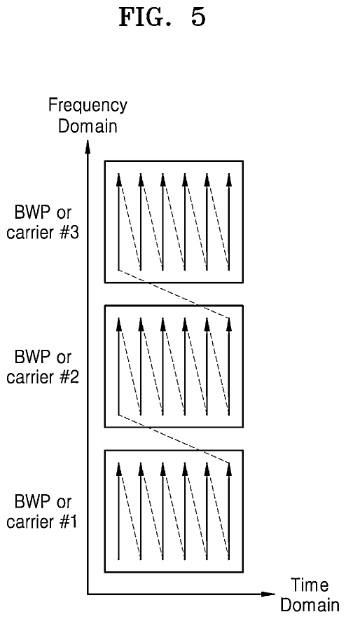

FIG. 5 illustrates a method of performing resource mapping according to an embodiment of the present application. Specifically, FIG. 5 illustrates a first mapping performed in a BWP in an order of frequency domain followed by time domain from the BWP with the lowest frequency, and the first mapping is repeated in the remaining BWPs.

Referring to FIG. 5, this method can be interpreted as mapping BWP by BWP or mapping carrier by carrier, mapping to the time/frequency RB allocated for each BWP in segments. The mapping starts from the BWP (or carrier with lowest frequency. After all REs allocated on this BWP (or carrier) are mapped, the next carrier with the lowest frequency is mapped until all BWPs (or carriers) are mapped. On the time/frequency RB allocated on each BWP, mapping may be performed in the frequency domain first, followed by the time domain.

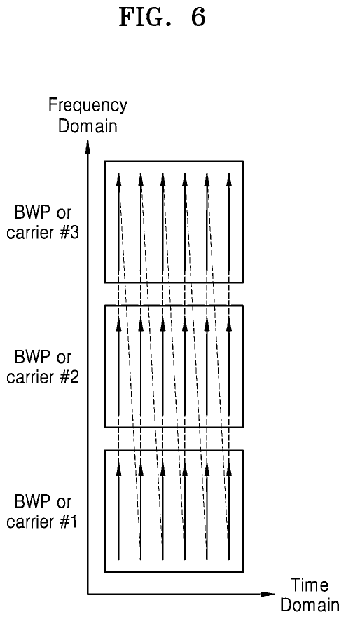

FIG. 6 illustrates another method of performing resource mapping according to an embodiment of the present application. Specifically, FIG. 6 illustrates a second mapping performed in a frequency order from the first time unit in time units, and the second mapping is repeated in the remaining time units.

Referring to FIG. 6, on a plurality of BWPs or carriers, mapping in frequency domain is performed first, followed by mapping in time domain. The time unit may be a symbol. That is, mapping starts from the RE with the lowest frequency in the first symbol until the REs on all carriers on this symbol are mapped, and mapping is then performed on the next symbol until all symbols are mapped.

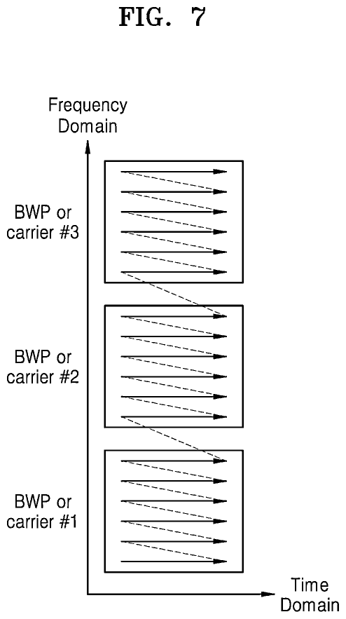

FIG. 7 illustrates another method of performing resource mapping according to an embodiment of the present application. Specifically, FIG. 7 illustrates a third mapping performed in a chronological order from the RE with the lowest frequency, and the third mapping is repeated in the remaining REs.

Referring to FIG. 7, on a plurality of BWPs or carriers, mapping in time domain is performed first, followed by mapping in frequency domain, as shown. The time unit may be a symbol. That is, mapping starts from the RE with the lowest frequency until all symbols corresponding to this RE are mapped, and mapping is then performed on the next RE with the lowest frequency until the REs on all BWPs or carriers are mapped.

When performing the segmented reception or transmission of the PDSCH or PUSCH scheduled by the DCI on the at least two BWPs, respectively, the second TBS of the PDSCH or PUSCH transmitted on the at least two BWP may be determined based on at least one of the following:
Method 10: the total number of REs determined based on the at least two BWPs.

By taking a PDSCH as an example, the second TBS may be determined according to the total number of REs allocated on all BWPs (or all carriers).

The number of PRBs allocated on different BWPs may be different, the number of symbols allocated on different BWPs may also be different, the DMRS patterns used on different BWPs may also be different (that is, the number of DMRS REs of each PRB on different BWPs may also be different), and the magnitudes of the signaling overheads Nₒₕ^{PRB} configured on different BWPs may also be different. The UE needs to respectively determine the number N_{RE,i} of REs on each BWP and then use the total number of REs on all BWPs as the number N_{RE} of REs for determining the second TBS. That is, N_{RE}=Σᵢ₌₀^{i=N-1} N_{RE,i}, where N is the number of activated BWPs (or the number of carriers) that transmit one TB, and N_{RE,i} is the number of RES on the ith activated BWP (or the ith carrier).

The number of PRBs allocated on different BWPs may be different, but the number of symbols allocated on the different BWPs is the same, the DMRS patterns used on different BWPs are also the same (that is, the number of DMRS REs of each PRB on different BWPs is also the same), and the magnitudes of the signaling overheads Nₒₕ^{PRB} on different BWPs are also the same. The UE first determines the number of REs in a PRB based on N_{RE}′=N_{sc}^{RB}·N_{symb}^{sh}−N_{DMRS}^{PRB}−Nₒₕ^{PRB}, and then determines the total number n_{PRB} of PRBs allocated on all BWPs, that is, n_{PRB}=Σᵢ₌₀^{i=N-1}n_{PRB,i}, where N is the number of activated BWPs (or the number of carriers) that transmit one TB, n_{PRB,i} is the number of PRBs allocated on the ith activated BWP (or the ith carrier), N_{sc}^{RB} is the number of REs included in a PRB, e.g., N_{sc}^{RB}=12, N_{symb}^{sh} is the number of PDSCH symbols allocated in a slot, N_{DMRS}^{PRB} is the number of REs used for DMRS in each PRB, and, Nₒₕ^{PRB} is the magnitudes of the signaling overhead configured through the high-layer parameter. Nₒₕ^{PRB} is the magnitude of the signaling overhead configured through the high-layer parameter. Then, the number of REs is determined based on N_{RE}=min (156, N_{RE}′)*PRB.
Method 11: a scaling factor corresponding to the second TBS.

The UE may use the value obtained by multiplying the total number of REs determined in method 10 by a scaling factor as the number N_{RE} of REs for determining the second TBS. Alternatively, the value obtained by multiplying the TBS determined in method 10 by a scaling factor is used as the TBS. The magnitude of the scaling factor may be configured through a high layer signaling. Different activated BWPs may be configured with different scaling factors.

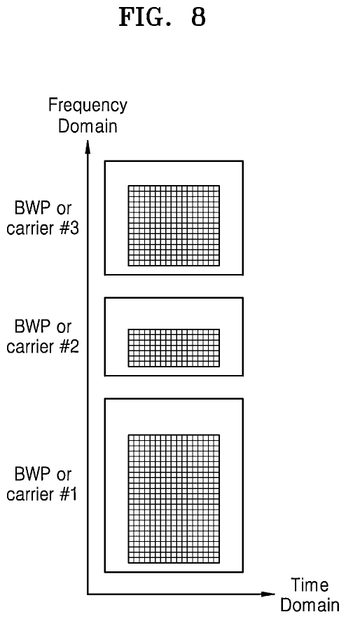

The DCI for scheduling the transmission across multiple carriers may indicate the time/frequency domain resource allocation information on a plurality of activated BWPs (i.e., a plurality of carriers), wherein the time domain resource allocation information of the PDSCH or PUSCH transmitted on the at least two BWPs included in the DCI includes at least one of the following situations:
(1) The at least two BWPs share the time domain resource allocation information, that is, the time domain resources allocated on a plurality of activated BWPs are identical, as shown in FIG. 8, including but not limited to the number of allocated slots and the positions of slots, as well as the number of symbols and the positions of symbols allocated in each slot. That is, the slots or symbols where the resources allocated on a plurality of activated BWPs are located are identical. The time domain resource indication field in the existing DCI may be reused.
(2) The at least two BWPs share the first time domain resource allocation information, and the second time domain resource allocation information other than the first time domain resource allocation information is configured for the at least two BWPs, respectively. That is, each BWP in the at least two BWPs shares partially the same time domain resource allocation information. The time domain resources allocated on a plurality of activated BWPs may be different, but may share partially the same time domain resource allocation indication information. A plurality of activated BWPs may share at least one of the same number of slots, the same positions of slots, the same number of symbols and the same positions of symbols. For example, the first time domain resource allocation information includes the number of time units allocated on a BWP, and the second time domain resource allocation information includes the positions of time units allocated on a BWP. That is, the number of slots or symbols allocated on a plurality of activated BWPs is the same, but the positions of slots or symbols may be different. The scheduling DCI may indicate the position of the starting slot or starting symbol for each activated BWP, respectively. For example, the scheduling DCI may indicate the corresponding scheduling delay information, respectively, and/or the scheduling DCI may indicate the positions of symbols in each allocated slot for each activated BWP, respectively.
(3) The time domain resource allocated on each BWP in the at least two BWPs is indicated by different fields in the DCI, respectively. That is, the time domain resources allocated on a plurality of activated BWPs may be different, and the time domain resources on each activated BWP are allocated independently. The time domain resource allocation on each activated BWP may be indicated separately. For example, the DCI includes time domain allocation indication fields, which correspond to different activated BWPs, respectively.

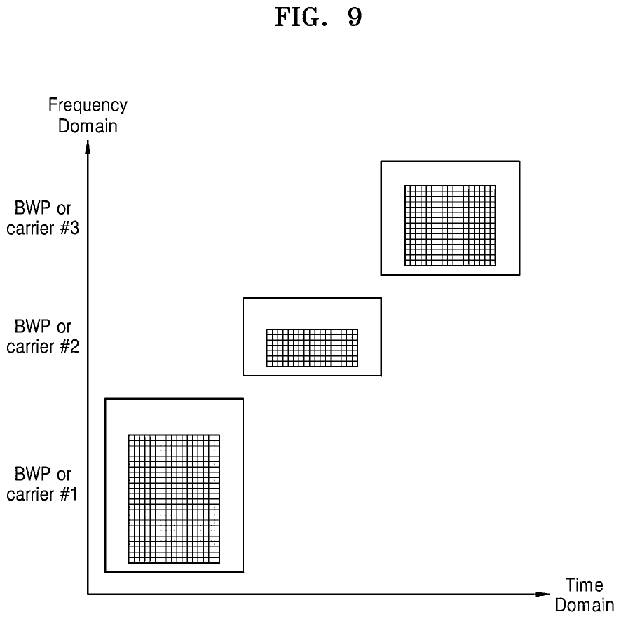

Alternatively, the time domain resource allocation information of the PDSCH or PUSCH transmitted on the at least two BWPs included in the DCI may include the numbers of time units allocated on the at least two BWPs being identical, and the positions of time units allocated on each BWP in the at least two BWPs being staggered. That is, the time domain resources allocated on a plurality of activated BWPs are completely staggered in time, as shown in FIG. 9. They may be staggered in time from low frequency to high frequency. The advantage of this scheme is that the UE does not need to support the capability to perform transmission or reception on a plurality of carriers, and the UE can perform transmission or reception on a plurality of carriers successively by RE retuning, thereby obtaining a better frequency diversity gain. To reserve the processing time required for the UE to perform radio frequency adjustment, a certain interval is reserved between transmission signals of two adjacent carriers. That is, a certain interval is reserved between time domain resources of adjacent two carriers.

There may be a same first preset interval between the positions of time units of every two adjacent BWPs, wherein the first preset interval is determined in at least one of the following manners: predefined, reported by the UE, preconfigured through a high layer signaling, and indicated through the DCI. In the first preset interval, the UE may switch from a BWP where a time unit before the first preset interval is located to a BWP where a time unit after the first preset interval is located to continue to perform the reception or transmission of the PDSCH or PUSCH scheduled by the DCI. That is, in the first preset interval, the UE may perform radio frequency adjustment, so as to switch from one BWP to the other BWP in the at least two BWPs to execute the reception or transmission of the PDSCH or PUSCH scheduled by the DCI. Optionally, in this scheme, the scheduling DCI may indicate the position of the first time unit allocated on each BWP (or carrier), respectively.

In at least one of the above embodiments, the DCI for scheduling the transmission across multiple carriers may indicate the frequency domain resource allocation information on a plurality of activated BWPs (i.e., a plurality of carriers), wherein the frequency domain resource allocation information on the at least two BWPs included in the DCI includes at least one of the following situations:
(1) The at least two BWPs share the frequency domain resource allocation information. That is, the number of PRBs and/or the positions of PRBs allocated on a plurality of activated BWPs are identical.
(2) The at least two BWPs share the first frequency domain resource allocation information, and the second frequency domain resource allocation information other than the first frequency domain resource allocation information is configured for the at least two BWPs, respectively. That is, each BWP in the at least two BWPs shares partially the same frequency domain resource allocation information. The number of PRBs or the positions of PRBs allocated on a plurality of activated BWPs may be different. For example, the number of PRBs allocated on a plurality of activated BWPs is the same, but the positions of PRBs are different. The scheduling DCI indicates the number of PRBs allocated on each BWP. In addition, the scheduling DCI may also indicate the position of the starting PRB (assuming that the allocated PRBs are consecutive) or the specific positions of PRBs (assuming that the allocated PRBs are not consecutive) on each activated BWP.
(3) The frequency domain resources allocated on each BWP in the at least two BWPs are indicated by different fields in the DCI, respectively. That is, the frequency domain allocations on a plurality of activated BWPs are indicated by different indication fields, respectively. For example, the scheduling DCI includes N frequency domain resource allocation indication fields, which correspond to N activated BWPs (or N carriers), respectively. The number of bits of each frequency domain resource allocation indication field is determined by the respective BWP bandwidth.
(4) The frequency domain resources allocated on the at least two BWPs are jointly indicated by a same field in the DCI, that is, the frequency domain resource allocations on a plurality of activated BWPs are jointly indicated based on the total bandwidth of a plurality of activated BWPs after aggregation. That is, the PRBs in a plurality of activated BWPs are numbered together, and/or the RBGs in a plurality of activated BWPs are numbered together. For example, the PRBs (or RBGs) in the first activated BWP at the low frequency position are sequentially numbered as #0 to #(N1-1) from low frequency to high frequency. That is, there are total N1 PRBs (or RBGs) on this activated BWP. Then, the RBGs in the next activated BWP at the low frequency position are sequentially numbered as #N1 to #(N2+N1-1) from low frequency to high frequency. There are total N2 PRBs (or RBGs) on this activated BWP. Deduction is performed on other activated BWPs in the same manner until the PRBs or RBGs of all activated BWPs are numbered. The number of PRBs or RBGs included in each activated BWP may be different. The scheduling DCI may indicate some of the PRBs or RBGs which are numbered together by the existing frequency domain resource indication method. The number of bits for indicating the frequency domain resource allocation is determined based on the total bandwidth after aggregation. This scheme may also be referred to as the frequency domain resource allocation based on the aggregated bandwidth.
(5) The frequency domain resources allocated on a part of BWPs in the at least two BWPs are indicated through the DCI, and the frequency domain resources allocated on another part of BWPs in the at least two BWPs are predefined or preconfigured through a high layer signaling. That is, in a plurality of activated BWPs, all PRBs in activated BWPs are allocated for transmission. The scheduling DCI does not need to indicate the frequency domain resource allocations on these particular activated BWPs, and only needs to indicate the frequency domain resource allocation information on other activated BWPs. The particular activated BWP may be a primary activated BWP (i.e., first BWP), an activated BWP with the smallest index number, an activated BWP on the anchor carrier, an activated BWP on a carrier with an index number of #0, an activated BWP on a carrier with the smallest index number in a plurality of carriers, an activated BWP on a carrier with the lowest frequency, a secondary activated BWP (i.e., second BWP), an activated BWP with a bandwidth less than a first preset value, an activated BWP with a bandwidth greater than a second preset value, a preconfigured activated BWP or the like, but not limited thereto.

Alternatively, the frequency domain resources allocated on the at least two BWPs being jointly indicated by a same field in the DCI may specifically include the following situation: at least one of PRBs, VRBs and RBGs on the at least two BWPs are numbered together.

For example, in the frequency domain resource allocation type (RA type) 0, the scheduling DCI indicate the allocated RBGs through a bit map, which can support consecutive or discrete RBG resource allocation. One RBG includes M consecutive PRBs.

For the frequency domain resource allocation method based on the aggregated bandwidth, to coexist with other scheduling UEs on each activated BWP (here, other scheduling UEs may have only one activated BWP), the RBG size on each activated BWP may be different, and the same RBG cannot cross carriers. That is, RBG at two ends of one activated BWP may not be a complete RBG, such that the number of PRBs included in the RBG at two ends may not be M.

The RBG size (i.e., the smallest granularity PBG size for the frequency domain resource allocation based on the aggregated bandwidth) is determined in at least one of the following manners:
(1) RBGs are divided in each BWP in the at least two BWPs based on a same BRG size, that is, all activated BWPs allocate the frequency domain resources in the BWPs by using the same RBG size. The RBG size is determined according to the bandwidth size of a particular BWP in the at least two BWPs. That is, the RBG size may be determined based on the bandwidth size (i.e., the number of included PRBs) of a particular activated BWP, or according to the total bandwidth size of the at least two BWPs. That is, the RBG size may be determined according to the total bandwidth size of all activated BWPs (i.e., the sum of the numbers of PRBs included in all activated BWPs). For example, the RBG size is determined based on Table 1 below. The particular BWP is predefined, or preconfigured through a high layer signaling. The particular BWP may be a primary activated BWP (i.e., first BWP), an activated BWP on an anchor carrier, an activated BWP on a carrier with the smallest index number, a preconfigured activated BWP or the like, but not limited thereto.
(2) RBGs are divided in each BWP in the at least two BWPs based on different RBG sizes, and the RBG sizes are determined according to the bandwidth size of each BWP, respectively. That is, each activated BWP allocates the frequency domain resources in the respective BWP by using a different RBG size. Each activated BWP may determine the RBG size according to the respective bandwidth size (i.e., the number of included PRBs). For example, the RBG size is determined based on Table 1 below.

TABLE 1

| BWP size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

Table 1 can be used for the determination of the RBG size according to the total bandwidth size of all activated BWPs, and \ for the determination of the corresponding RBG size according to the bandwidth size of each BWP, respectively. Due to different bandwidth sizes, the determined RBG size may also be different.

Alternatively, considering the compatibility with other UEs based on one activated carrier transmission, the RBG division on each activated BWP should be aligned with the carrier resource block (CRB) of the carrier where the BWP is located, that is, the starting position of the RBG on each carrier should be aligned with the starting position of the CRB of the carrier where the BWP is located. That is, the RBG division on each BWP starts from CRB0 with the lowest frequency in the carrier where the BWP is located.

Alternatively, the RBG division on each BWP starts from CRB0 with the lowest frequency in the reference carrier, that is, the RBGs on each BWP are divided based on the same CRB0. The reference carrier is a predefined one of the carriers where each BWP is located.

In RA Type1, the scheduling DCI jointly indicate the starting VRB position and the number of consecutive VRBs by using a start and length indicator value (SLIV), wherein there are two mapping modes between VRBs and PRBs. The first mapping mode is non-interlaced mapping, that is, a group of consecutive VRBs corresponds to a group of consecutive PRBs, and resource scheduling only supports consecutive RPB allocation. The second mapping mode is interlaced mapping. That is, a group of consecutive VRBs may correspond to a group of discrete PRBs, and resource scheduling may support consecutive or discrete PRB allocation. When the frequency domain resources allocated on each BWP in the at least two BWPs is jointly indicated by the same field in the DCI, the mapping mode for VRBs and PRBs includes at least one of the following:
(1) Non-interlaced mapping: that is, VRBs and PRBs are mapped one by one. That is, the VRB numbered as #n corresponds to the PRB numbered as #n, and the numbers of VRBs and corresponding PRBs are identical.
(2) within the respective bandwidth of each BWP, VRBs and PRBs are mapped in an interlaced manner. That is, only within a carrier, VRBs and PRBs are mapped in an interlaced manner. That is, a group of consecutive VRBs may correspond to a group of discrete PRBs. However, this interlacement is only limited within a carrier, and cannot cross carriers. For example, it is assumed that there are three activated BWPs. The PRBs on the first activated BWP are numbered as #0 to #(N1−1), such that here are total N1 PRBs on the first activated BWP. The PRBs on the second activated BWP are numbered as #N1 to #(N2+N1−1), such that there are total N2 PRBs in the second activated BWP. The PRBs on the third activated BWP are numbered as #(N1+N2) to #(N3+N2+N1−1), such that there are total N3 PRBs on the third activated BWP. Thus, VRBs and PRBs may be mapped in a segmented manner. That is, the VRBs numbered as #0 to #(N1−1) correspond to the PRBs numbered as #0 to #(N1−1), the VRBs numbered as #N1 to #(N2+N1−1) correspond to the PRBs numbered as #N1 to #(N2+N1−1), and the VRBs numbered as #(N1+N2) to #(N3+N2+N1−1) correspond to the PRBs numbered as #(N1+N2) to #(N3+N2+N1−1). However, the VRB numbered as #m does not necessarily correspond to the PRB numbered as #m. That is, VRBs and PRBs are mapped in a segmented and interlaced manner, and the segmented interval is within the carrier. In each carrier, the mapping rule may reuse the mapping rule of the existing system.
(3) Within the total bandwidth of the at least two BWPs, VRBs and PRBs are mapped in an interlaced manner. That is, across carriers, VRBs and PRBs are mapped in an interlaced manner. That is, a group of consecutive VRBs may correspond to a group of discrete PRBs, and this interlacement can be across carriers. For example, the existing rule may reuse of the mapping rule of the existing system, except for the difference that the aggregated bandwidth of a plurality of carriers may be processed as a carrier with a larger bandwidth.

The PDSCH transmitted on the at least two BWPs includes a semi-persistent scheduling physical DL shared channel (SPS-PDSCH), and the PUSCH transmitted on the at least two BWPs includes a type 1 preconfigured grant physical UL shared channel (CG-PUSCH) and a type 2 CG-PUSCH.

That is, the dynamic scheduling-free TB may be configured as being transmitted across multiple carriers. For example, the CG-PUSCH may be configured as being transmitted across multiple carriers, and the SPS-PDSCH may also be configured as being transmitted across multiple carriers. For example, CG-PUSCH Type 1 configures, through a high layer signaling, that the resource allocations on a plurality of BWPs are used for the transmission of the same CG-PUSCH (i.e., the same TB), CG-PUSCH Type 2 indicates that the resource allocations on a plurality of BWPs are used for the transmission of the same CG-PUSCH (i.e., the same TB) by activating the DCI, and SPS-PDSCH indicates that the resources on a plurality of BWPs are used for the same SPS-PDSCH (i.e., the same TB) by activating the DCI.

For the CG-PUSCH transmitted across multiple carries, the corresponding first hybrid automatic repeat request process (HARQ) process number (i.e., the ID of the HARQ process) may be determined by Equation (1) below.

$$HARQ Process ID = [ floor ( CURRENT\_symbol / periodicity ) ] modulo nrofHARQ - Processes + harq - ProcID - Offset \qquad ( 1 )$$

In Equation (1), modulo represents a modular operation, floor represents downward rounding, periodicity is the preconfigured transmission periodicity of the CG-PUSCH, nrofHARQ-Processes is the preconfigured number of HARQ processes for CG-PUSCH transmission, harq-ProcID-Offset is the preconfigured offset for determining the HARQ process number, and, CURRENT_symbol=(SFN×numberOfSlotsPerFrame×numberOfSymbolsPerSlot+slot number in the frame×numberOfSymbolsPerSlot+symbol number in the slot, where SFN is a system frame number, numberOfSlotsPerFrame is the number of slots included in a radio frame, numberOfSymbolsPerSlot is the number of OFDM symbols included in a slot, slot number in the frame is the index number of the slot, where the CG-PUSCH transmission is located, in the radio frame, and symbol number in the slot is the index number of the starting symbol of the CG-PUSCH transmission in the slot.

If the position of the first OFDM symbol used for CG-PUSCH transmission allocated on each carrier is not exactly the same (for example, the staggered resource allocation method in time domain described above), for the CG-PUSCH, the corresponding first HARQ process number is determined based on the earliest first time unit allocated on the at least two BWPs. That is, the above symbol number in the slot refers to the index number of the earliest first OFDM symbol allocated on a plurality of carriers in the slot, and the above slot number in the frame refers to the index number of the slot, where the earliest first OFDM symbol allocated on a plurality of carriers is located, in the radio frame.

Regardless of whether the position of the first OFDM symbol used for CG-PUSCH transmission allocated on each carrier is the same, for the CG-PUSCH, the corresponding first HARQ process number is determined based on the first time unit (e.g., OFDM symbol) allocated on a preset BWP of the at least two BWPs. That is, the above symbol number in the slot refers to the index number of the first OFDM symbol allocated on the preset BWP in the slot, and the above slot number in the frame refers to the index number of the slot, where the first OFDM symbol allocated on the preset BWP is located, in the radio frame. The preset BWP is predefined or preconfigured. For example, the preset BWP may be the above first BWP, or the preset BWP may be a preconfigured BWP in the above at least two BWPs.

For the SPS-PDSCH transmitted across multiple carriers, the corresponding second HARQ process number may be determined by Equation (2) below.

$$HARQ Process ID = [ floor ( CURRENT\_slot \times 10 / ( numberOfSlotsPerFrame \times periodicity ) ) ] modulo nrofHARQ - Processes + harq - ProcID - Offset \qquad ( 2 )$$

In Equation (2), modulo represents a modular operation, floor represents downward rounding, periodicity is the preconfigured transmission periodicity of the SPS-PDSCH, nrofHARQ-Processes is the preconfigured number of HARQ processes for SPS-PDSCH transmission, harq-ProcID-Offset is the preconfigured offset for determining the HARQ process number, numberOfSlotsPerFrame is the number of slots included a ratio frame, and, CURRENT_slot=[(SFN×numberOfSlotsPerFrame)+slot number in the frame], where SFN is a system frame number, and slot number in the frame is the index number of the slot, where the SPS-PDSCH transmission is located, in the radio frame.

If the slot used for SPS-PDSCH transmission allocated on each carrier is not exactly the same (for example, the staggered resource allocation method in time domain described above), for the SPS-PDSCH, the corresponding second HARQ process number is determined based on the earliest first time unit allocated on the at least two BWPs. That is, the above slot number in the frame refers to the index number of the earliest slot in the resources allocated on a plurality of carriers in the radio frame.

Regardless of whether the position of the first slot used for SPS-PDSCH transmission allocated on each carrier is the same, for the SPS-PDSCH, the corresponding second HARQ process number is determined based on the first time unit allocated on a preset BWP of the at least two BWPs. For example, the above slot number in the frame refers to the index number of the first slot allocated on the preset BWP in the radio frame. The preset BWP is predefined or preconfigured. For example, the preset BWP may be the above first BWP, or the preset BWP may be a preconfigured BWP in the above at least two BWPs.

If any one BWP in the at least two BWPs is deactivated, the method performed by a UE further includes at least one of the following:
(1) Stopping the transmission of the SPS-PDSCH or CG-PUSCH on the at least two BWPs, and performing at least one of: clearing DL allocation of the SPS-PDSCH, clearing UL grant of the type 2 CG-PUSCH and interrupting/releasing UL grand of the type 1 CG-PUSCH.

That is, if the SPS-PDSCH or CG-PUSCH is configured to be transmitted on N BWPs and one BWP in the N BWPs is deactivated such that the N BWPs are not all activated, the SPS-PDSCH or CG-PUSCH cannot be transmitted, and the MAC layer of the UE may clear the DL allocation of the SPS-PDSCH and/or clear the UL grant of the CG-PUSCH Type 2 and/or interrupt the UL grant of the CG-PUSCH Type 1.
(2) The transmission of the SPS-PDSCH or CG-PUSCH is performed on the un-deactivated BWP in the at least two BWPs.

That is, If the SPS-PDSCH or CG-PUSCH is configured to be transmitted on N BWPs and one BWP or no more than a preset number of BWPs in the N BWPs are deactivated, that is, the N BWPs are not all activated, the SPS-PDSCH or CG-PUSCH cannot be transmitted on the un-activated BWP, but the SPS-PDSCH or CG-PUSCH can be transmitted on the activated BWP. This scheme can correspond to the cross-carrier transmission mode based on repetitive transmission described herein. That is, when a part of BWPs are deactivated, some repetitive transmissions may still achieve the effect of correct decoding, without affecting the transmission of the SPS-PDSCH or CG-PUSCH on other activated BWPs. For this scheme, after the N activated BWPs are all deactivated, the MAC layer of the UE clears the DL allocation of the SPS-PDSCH and/or clears the UL grant of the CG-PUSCH Type 2 and/or interrupts the UL grant of the CG-PUSCH Type 1.

Based on transmitting a TB across a plurality of activated BWPs, an optional implementation is provided for step S402 in FIG. 4, including determining, according to an indication of a resource indication field in the DCI, at least one scheduled BWP in the at least two BWPs, and performing the reception or transmission of the PDSCH or PUSCH scheduled by the DCI on the at least one scheduled BWP.

The scheduling DCI may schedule the transmission of a TB (e.g., a PDSCH or a PUSCH) on X BWPs, where 1≤XEN, and N is the number of activated BWPs. That is, the scheduled BWP may be one or more of the activated BWPs, and the number of scheduled BWPs cannot exceed the number of activated BWPs.

The DCI includes an indication field for indicating which BWPs in the N activated BWPs are scheduled. For example, the scheduling DCI may include indication information related to the scheduled BWP and/or the carrier where the scheduled BWP is located, and may include X resource indication fields which correspond to X scheduled BWPs, respectively, and each resource indication field is used for indicating the time domain and/or frequency domain resource allocation on the corresponding BWP.

For example, it is assumed there are total four activated BWPs. When only one activated BWP is scheduled, the scheduling DCI may include a 2-bit indication field for indicating that one of the four activated BWPs is scheduled. Alternatively, when one or more activated BWPs are scheduled, the scheduling DCI may include a 4-bit indication field, and it is indicated that, by a bit map, which activated BWPs in the four activated BWPs are scheduled. In other words, each bit corresponds to one activated BWP. When the indication value is “1”, the corresponding activated BWP is scheduled. When the indication value is “1”, the corresponding activated BWP is not scheduled. Alternatively, when one or more activated BWPs are scheduled, the scheduling DCI may include an indication field for indicating the index number of the scheduled BWP set, wherein the BWP set is preconfigured through a high layer signaling.

Whether one activated BWP is scheduled is indicated by its corresponding resource indication field. For example, the DCI includes N resource indication fields which correspond to N activated BWPs, and each resource indication field is used for indicating the time domain and/or frequency domain resource allocation on the corresponding BWP. When the value of a resource indication field is a preset state value (for example, if it is assumed that resource indication field includes 7 bits, the preset state value may be “0000000” or “1111111”), it indicates that the corresponding BWP are not scheduled for transmission, that is, the transmissions on some activated BWPs are dynamically scheduled by the preset state value of the resource indication field.

Alternatively, in the above at least one embodiment of transmitting a TB across a plurality of activated BWPs, there may be certain requirements for a plurality of activated BWPs used for transmission. For example, performing the transmission of the same PDSCH or PUSCH scheduled by the DCI on the N activated BWPs (or N carriers) is supported, when at least one of the following conditions are satisfied for N activated BWPs (or N carriers):
(1) the frequency domain interval between two adjacent carriers in the frequency domain in the at least two BWPs does not exceed a first preset bandwidth, that is, the frequency domain interval between two carriers that are close in the frequency domain in the N activated BWPs (or N carriers) does not exceed the first preset bandwidth;
(2) the bandwidth between the lowest frequency and the highest frequency in the at least two BWPs does not exceed a second preset bandwidth. That is, the overall bandwidth of the N activated BWPs (or N carriers) does not exceed the second preset bandwidth, where the overall bandwidth refers to the bandwidth occupied between the lowest frequency and the highest frequency of the N activated BWPs (or N carriers); and
(3) the sum of the bandwidths of the at least two BWPs does not exceed a third preset bandwidth, that is, the sum of the bandwidths of the N activated BWPs (or N carriers) does not exceed a third preset bandwidth.

Alternatively, in transmitting a TB across a plurality of activated BWPs, the scheduling DCI may be transmitted on one activated BWP in the plurality of activated BWPs, and the method performed by a UE further includes monitoring the PDCCH corresponding to the DCI on a particular BWP in the at least two BWPs. In other words, the UE monitors the PDCCH in one of the activated BWPs, and does not need to monitor the PDCCH on all the activated BWPs. The particular BWP is predefined, or configured through a high layer signaling. Specifically, the UE monitoring the activated BWP where the PDCCH is located may be at least one of the following situations:
(1) The PDCCH is monitored on a predefined activated BWP in a plurality of activated BWPs, such as a primary activated BWP (i.e., first BWP), an activated BWP with the smallest index number, an activated BWP on an anchor carrier, an activated BWP on a carrier with an index number of #0, an activated BWP on a carrier with the smallest index number in a plurality of carriers, or an activated BWP on a carrier with the lowest frequency.
(2) The PDCCH is monitored on a preconfigured activated BWP in a plurality of activated BWPs. For example, it is possible that the PDCCH transmission is configured on any activated BWP, depending on the configuration of the BS. The PDCCH transmission can be configured on one and only one activated BWP in the plurality of activated BWPs.

Alternatively, in transmitting a TB across a plurality of activated BWPs, the UE may be configured a PDSCH parameter or a PUSCH parameter on each activated BWP, respectively. When the UE is scheduled to transmit a PDSCH or PUSCH across a plurality of activated BWPs, the configuration related to the PDSCH or PUSCH transmitted on the at least two BWPs complies with at least one of the following configurations:
(1) A configuration related to the PDSCH or PUSCH on a particular BWP in the at least two BWPs, the particular BWP being predefined or preconfigured through a high layer signaling.

That is, the PDSCH (or PUSCH) transmitted across a plurality of activated BWPs complies with the PDSCH configuration (or PUSCH configuration) on a predefined activated BWP in a plurality of activated BWPs, a primary activated BWP (i.e., first BWP), an activated BWP with the smallest index number, an activated BWP on an anchor carrier, an activated BWP on a carrier with an index number of #0, an activated BWP on a carrier with the smallest index number in a plurality of carriers or an activated BWP on a carrier with the lowest frequency.

Alternatively, the PDSCH (or PUSCH) transmitted across a plurality of activated BWPs complies with the PDSCH configuration (or PUSCH configuration) on a preconfigured activated BWP in a plurality of activated BWPs, one of a plurality of activated BWPs configured through a high layer signaling, or one of a plurality of activated BWPs indicated through the scheduling DCI.
(2) A configuration related to a dedicated PDSCH or PUSCH, the configuration related to the dedicated PDSCH or PUSCH being different from the configuration related to the PDSCH or PUSCH on each BWP in the at least two BWPs.

That is, the PDSCH (or PUSCH) transmitted across a plurality of activated BWPs complies with a dedicated PDSCH configuration (or PUSCH configuration), and the dedicated PDSCH configuration (or PUSCH configuration) is different from the respective PDSCH configuration (or PUSCH configuration) of each activated BWP.

Alternatively, in the above at least one embodiment of transmitting a TB across a plurality of activated BWPs, considering the compatibility with other UEs based on one activated BWP transmission for DMRS, the DMRS signal sequence of the PDSCH or PUSCH on each carrier is generated separately. The DMRS signal sequence transmitted on each BWP is separately generated based on at least one of the following:
(1) an index number of a CRB corresponding to the PRB where the DMRS is located, where the CRB index is the number of this PRB relative to the first RB (i.e., CRB #0) of the located carrier, that is, the index number of the CRB is numbered from the CRB0 of the carrier where the DMRS is located, or the index number of the CRB is numbered from the CRB0 of the carrier where the BWP with the lowest frequency in the at least two BWPs is located;
(2) an index number of the carrier where the DMRS is located; and
(3) a dedicated parameter corresponding to the BWP where the DMRS is located, the dedicated parameter being configured based on each BWP, respectively, that is, a parameter used for generating the DMRS signal sequence being configured on each carrier, respectively.

In the method performed by a UE, the multi-carrier configuration in one serving cell is enabled. Compared with the aggregation of a plurality of carriers by aggregating a plurality of serving cells, the aggregation of a plurality of carriers in one serving cell is more flexible, and can simplify the system and reduce signaling overhead.

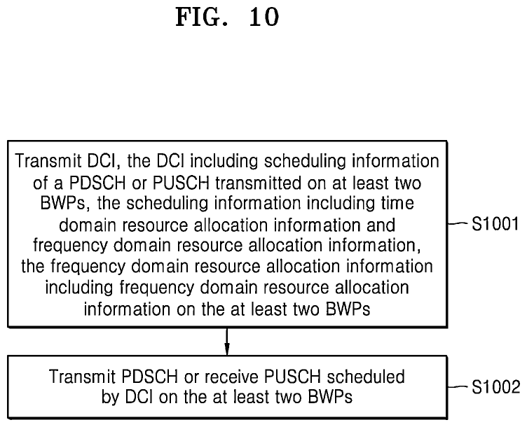

FIG. 10 illustrates a method performed by a BS in a communication system according to an embodiment.

Referring to FIG. 10, in step S1001, DCI is transmitted, the DCI including scheduling information of a PDSCH or PUSCH transmitted on at least two BWPs, wherein the scheduling information including time domain resource allocation information and frequency domain resource allocation information, wherein the frequency domain resource allocation information including frequency domain resource allocation information on the at least two BWPs.

In step S1002, the transmission of a PDSCH or PUSCH scheduled by the DCI is performed on the at least two BWPs.

The frequency domain resources included in each of the at least two BWPs do not overlap.

The at least two BWPs are located on different carriers, respectively.

The carriers where the at least two BWPs are located respectively are configured in a same serving cell.

The at least two BWPs include one first BWP and at least one second BWP, and the at least two BWPs include at least one of the first BWP and the second BWP sharing a configuration of the PDSCH and/or PUSCH, and the first BWP and the second BWP sharing a configuration of a first parameter of the PDSCH and/or PUSCH, and a second parameter other than the first parameter is configured for the first BWP and the second BWP, respectively.

The first BWP includes at least one of:
the first BWP is a BWP on an anchor carrier,
the first BWP is a BWP on a carrier with an index number of 0,
the first BWP is a BWP on a carrier with the smallest index number,
the first BWP is a BWP on a carrier with the lowest frequency, and
the first BWP is a BWP configured through a high layer signaling.

The first BWP is used to transmit a physical control channel and a physical shared channel, and the second BWP is used to transmit a physical shared channel.

Step S1101 further includes at least one of:
transmitting a PDCCH on a first preset BWP of the at least two BWPs, the PDCCH including scheduling information related to the at least two BWPs, and
receiving a PUCCH on a second preset BWP of the at least two BWPs, the PUCCH including UL control information related to the at least two BWPs,
wherein the first preset BWP and/or the second preset BWP is the first BWP, or the first preset BWP and/or the second preset BWP is configured as one of the at least two BWPs.

Receiving or transmitting the PDSCH or PUSCH scheduled by the DCI on the at least two BWPs includes at least one of the following manners:
performing the repetitive reception or transmission of the PDSCH or PUSCH scheduled by the DCI on the at least two BWPs, respectively, and
performing the segmented reception or transmission of a PDSCH or PUSCH scheduled by the DCI on the at least two BWPs, respectively.

When performing the repetitive reception or transmission of the PDSCH or PUSCH scheduled by the DCI on the at least two BWPs, respectively, the method further includes:
determining a first TBS of the PDSCH or PUSCH transmitted on the at least two BWPs based on at least one of:
the average number of REs determined based on the at least two BWPs,
the maximum value among the numbers of REs respectively determined based on each BWP in the at least two BWPs,
the minimum value of the numbers of REs respectively determined based on each BWP in the at least two BWPs,
the number of REs determined based on a preset BWP of the at least two BWPs, and
a scaling factor corresponding to the first TBS.

When performing the repetitive reception or transmission of the PDSCH or PUSCH scheduled by the DCI on the at least two BWPs, respectively, the method further includes:
determining RVs of the PDSCH or PUSCH on each BWP in the at least two BWPs in at least one of the following manners:
the RVs of the PDSCH or PUSCH on the at least two BWPs are identical,
the RV of the PDSCH or PUSCH on each BWP in the at least two BWPs is different,
the RV of the PDSCH or PUSCH on each BWP in the at least two BWPs is different, each RV is determined by an RV order, and each BWP in the at least two BWPs cyclically corresponds to each RV in the RV order successively, and
the RV transmitted on each BWP in the at least two BWPs is different, each RV is determined by an RV order and a starting RV, and each BWP in the at least two BWPs cyclically corresponds to each RV in the RV order successively from the starting RV.

The RV order is {#0, #1, #2, #3} or {#0, #2, #3, #1}.

When performing the segmented reception or transmission of the PDSCH or PUSCH scheduled by the DCI on the at least two BWPs, respectively, the method further includes:
performing a process of mapping the PDSCH or PUSCH scheduled by the DCI to a physical resource in at least one of the following manners:
performing first mapping in an order of frequency domain followed by time domain from a BWP with the lowest frequency in BWPs, and repeating the first mapping in the remaining BWPs,
performing second mapping in a frequency order from a first time unit in time units, and repeating the second mapping in the remaining time units, and
performing third mapping in a chronological order from a RE with the lowest frequency, and repeating the third mapping in the remaining REs.

When performing the segmented reception or transmission of the PDSCH or PUSCH scheduled by the DCI on the at least two BWPs, respectively, the method further includes:
determining a second TBS of the PDSCH or PUSCH transmitted on the at least two BWPs based on at least one of:
the total number of REs determined based on the at least two BWPs, and
a scaling factor corresponding to the second TBS.

The time domain resource allocation information of the PDSCH or PUSCH transmitted on the at least two BWPs included in the DCI includes at least one of the following situations:
the at least two BWPs share the time domain resource allocation information,
the at least two BWPs share first time domain resource allocation information, and second time resource allocation information other than the first time domain resource allocation information is configured for the at least two BWPs, respectively, and
time domain resource allocated on each BWP in the at least two BWPs are indicated by different fields in the DCI, respectively.

The first time domain resource allocation information includes the number of time units allocated on a BWP, and,
the second time domain resource allocation information includes the positions of time units allocated on a BWP.

The time domain resource allocation information of the PDSCH or PUSCH transmitted on the at least two BWPs included in the DCI includes: the number of time units allocated on each BWP in the at least two BWPs are identical, and the positions of time units allocated on each BWP in the at least two BWPs are completely staggered.

The positions of time units allocated on each BWP in the at least two BWPs being staggered includes: there is a same first preset interval between the positions of time units of every two adjacent BWPs.

The performing the reception or transmission of the PDSCH or PUSCH scheduled by the DCI on the at least two BWPs includes: in the first preset interval, switching from a BWP where a time unit before the first preset interval is located to a BWP where a time unit after the first preset interval is located to continue to perform the reception or transmission of the PDSCH or PUSCH scheduled by the DCI.

The frequency domain resource allocation information on the at least two BWPs included in the DCI includes at least one of the following situations:
the at least two BWPs share the frequency domain resource allocation information,
the at least two BWPs share first frequency domain resource allocation information, and second frequency resource allocation information other than the first frequency domain resource allocation information is configured for the at least two BWPs, respectively,
frequency domain resources allocated on each BWP in the at least two BWPs are indicated by different fields in the DCI, respectively,
frequency domain resources allocated on the at least two BWPs are jointly indicated by a same field in the DCI, and
frequency domain resources allocated on a part of BWPs in the at least two BWPs are indicated through the DCI, and frequency domain resources allocated on another part of BWPs in the at least two BWPs are predefined or preconfigured through a high layer signaling.

At least one of PRBs, VRBs and RBGs) on the at least two BWPs are numbered together.

An RBG size is determined in at least one of the following manners:
RBGs are divided in each BWP in the at least two BWPs based on a same BRG size, the RBG size is determined according to the bandwidth size of a particular BWP in the at least two BWPs, or the RBG size is determined according to the total bandwidth size of the at least two BWPs, wherein the particular BWP is predefined or preconfigured through a high layer signaling, and
RBGs are divided in each BWP in the at least two BWPs based on different RBG sizes, and the RBG sizes are determined according to the bandwidth size of each BWP, respectively.

The RBG division on each BWP starts from CRB0 with the lowest frequency of a reference carrier that is a predefined one of the carriers where each BWP is located.

A mapping mode for VRBs and PRBs includes at least one of:
within the respective bandwidth of each BWP, VRBs and PRBs are mapped in an interlaced manner, and
within the total bandwidth of the at least two BWPs, VRBs and PRBs are mapped in an interlaced manner.

The PDSCH transmitted on the at least two BWPs includes an SPS-PDSCH, and the PUSCH transmitted on the at least two BWPs include a type 1 CG-PUSCH and a type 2 CG-PUSCH.

For the CG-PUSCH, the corresponding first HARQ process number is determined based on the earliest first time unit allocated on the at least two BWPs, Alternatively, the corresponding first HARQ process number is determined based on the first time unit allocated on a preset BWP of the at least two BWPs, wherein the preset BWP is predefined or preconfigured.

For the SPS-PDSCH, the corresponding second HARQ process number is determined based on the earliest first time unit allocated on the at least two BWPs, Alternatively, the corresponding second HARQ process number is determined based on the first time unit allocated on a preset BWP of the at least two BWPs, wherein the preset BWP is predefined or preconfigured.

If any BWP in the at least two BWPs is deactivated, the method further includes at least one of:
stopping the transmission of the SPS-PDSCH or CG-PUSCH on the at least two BWPs, and
performing the transmission of the SPS-PDSCH or CG-PUSCH on the un-deactivated BWP in the at least two BWPs.

The performing the reception or transmission of the PDSCH or PUSCH scheduled by the DCI on the at least two BWPs includes:
determining at least one scheduled BWP in the at least two BWPs, and
performing the reception or transmission of the PDSCH or PUSCH scheduled by the DCI on the at least one scheduled BWP.

The method further includes: indicating the at least one scheduled BWP in the at least two BWPs by a resource indication field in the DCI.

The reception or transmission of the PDSCH or PUSCH scheduled by the DCI is performed on the at least two BWPs, in a case that at least one of the following conditions is satisfied for at least two BWPs:
the frequency domain interval between two adjacent carriers in the frequency domain in the at least two BWPs does not exceed a first preset bandwidth,
the bandwidth between the lowest frequency and the highest frequency in the at least two BWPs does not exceed a second preset bandwidth, and
the sum of the bandwidths of the at least two BWPs does not exceed a third preset bandwidth.

The method further includes: transmitting a physical DL control channel (PDCCH) corresponding to the DCI on a particular BWP in the at least two BWPs, the particular BWP being predefined or preconfigured through a high layer signaling.

The configuration related to the PDSCH or PUSCH transmitted on the at least two BWPs complies with at least one of the following configurations:
a configuration related to the PDSCH or PUSCH on a particular BWP in the at least two BWPs, the particular BWP being predefined or preconfigured through a high layer signaling, and
a configuration related to a dedicated PDSCH or PUSCH, the configuration related to the dedicated PDSCH or PUSCH being different from the configuration related to the PDSCH or PUSCH on each BWP in the at least two BWPs.

The DMRS signal sequence transmitted on each BWP is separately generated based on at least one of:
an index number of a CRB corresponding to the PRB where the DMRS is located, the index number of the CRB being numbered from CRB0 of the carrier where a DMRS is located, or the index number of the CRB being numbered from CRB0 of the carrier where the BWP with the lowest frequency in the at least two BWPs is located,
an index number of the carrier where the DMRS is located, and
a dedicated parameter corresponding to the BWP where the DMRS is located, the dedicated parameter being configured based on each BWP, respectively.

The particular BWP being predefined includes at least one of:
the particular BWP is the first BWP,
the particular BWP is the second BWP,
the particular BWP is a BWP on an anchor carrier,
the particular BWP is a BWP on a carrier with an index number of 0,
the particular BWP is a BWP on a carrier with the smallest index number,
the particular BWP is a BWP on a carrier with the lowest frequency,
the particular BWP is a BWP having a bandwidth less than a first preset value, and
the particular BWP is a BWP having a bandwidth greater than a second preset value.

In the method performed by a BS, by deploying a plurality of carriers, the multi-carrier configuration in one serving cell becomes possible. Compared with the conventional aggregation of a plurality of carriers by aggregating a plurality of serving cells, the aggregation of a plurality of carriers in one serving cell by at least two BWPs with non-overlapped frequency domain resources is more flexible, and can simplify the system and reduce signaling overhead. In addition, the method performed by a BS provided in the embodiment of the disclosure supports that a plurality of DL carriers and more than two UL carriers in one serving cell. Herein, the reception or transmission of the PDSCH or PUSCH scheduled by the DCI can be simultaneously executed by using a plurality of carriers in one serving cell. That is, a TB can be transmitted across a plurality of carriers in one serving cell, thereby obtaining a frequency diversity gain or improving the peak rate.

As described above, an electronic device includes a transceiver, which is configured to transmit and receive signals, and a processor coupled to the transceiver and configured to implement the steps in the above method embodiments. When the electronic device is a UE, the processor is configured to implement the steps in the embodiments of the method performed by a UE. The detailed functional description and the achieved beneficial effects can refer to the above description of the embodiments of the method performed by a UE and will not be repeated here. If the electronic device is a BS, the processor is configured to implement the steps in the embodiments of the method performed by a BS. The detailed functional description and the achieved beneficial effects can specifically refer to the above description of the embodiments of the method performed by a BS and will not be repeated here. In practical applications, the UE or the BS can be construed as different network nodes.

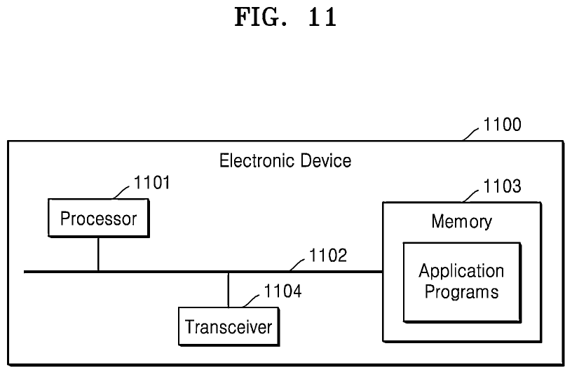

FIG. 11 illustrates the structure of an electronic device to which the disclosure is applied. The electronic device may include user equipment. Referring to FIG. 11, the electronic device 111100 may include a processor 111101 and a memory 1103. The processor 1101 is connected to the memory 1103, through a bus 1102. The electronic device 1100 may further include a transceiver 1104, and the transceiver 1104 may be used for data interaction between the electronic device and other electronic devices, data transmission and/or data reception. It should be noted that, in practical applications, the transceiver 1104 is not limited to one, and the structure of the electronic device 1100 does not constitute a limitation to the embodiments of the disclosure. The electronic device may be a first network node, a second network node or a third network node.

The processor 1101 may be a CPU, a general-purpose processor, a digital signal processor (DSP), an application specific integrated circuit (ASIC), or a field programmable gate array (FPGA), or other programmable logic devices, transistor logic devices, hardware components, or any combination thereof. The processor can implement or execute various exemplary logic blocks, modules and circuits described in the disclosure of the disclosure. The processor 1101 may also be a combination for realizing computing functions, a combination of one or more microprocessors, a combination of a DSP and a microprocessor, etc.

The bus 1102 may include a path to transfer information between the components described above. The bus 1102 may be a peripheral component interconnect (PCI) bus, or an extended industry standard architecture (EISA) bus, etc. The bus 1102 may be an address bus, a data bus, a control bus, etc. For ease of presentation, the bus is represented by only one thick line in FIG. 11. However, it does not mean that there is only one bus or one type of buses.

The memory 1103 may be, but is not limited to, read only memories (ROMs) or other types of static storage devices that can store static information and instructions, RAMs or other types of dynamic storage devices that can store information and instructions, may be electrically erasable programmable read only memories (EEPROMs), compact disc read only memories (CD-ROMs) or other optical disk storages, optical disc storages (including compact discs, laser discs, discs, digital versatile discs, Blu-ray discs, etc.), magnetic storage media or other magnetic storage devices, or any other media that can carry or store desired programs and that can be accessed by computers.

The memory 1103 is configured to store computer programs for executing the embodiments of the disclosure, and the execution is controlled by the processor 1101. The processor 1101 is configured to execute the application programs 1105 stored in the memory 1103 to implement the steps of the foregoing method embodiments.

The disclosure provides a computer-readable storage medium having computer programs stored thereon that, when executed by a processor, can implement the steps and corresponding contents in the above method embodiments.

An embodiment of the disclosure further provides a non-transitory computer readable recording medium, comprising computer programs that, when executed by a processor, can implement the steps and corresponding contents in the above method embodiments.

In accordance with an aspect of the disclosure, a method performed by a user equipment (UE) includes receiving downlink control information (DCI), the DCI including scheduling information of a physical downlink shared channel (PDSCH) or physical uplink shared channel (PUSCH) transmitted on at least two bandwidth parts (BWPs), wherein the at least two BWPs including one first BWP and at least one second BWP are configured in one serving cell, and receiving the PDSCH or transmitting the PUSCH scheduled by the DCI on the at least two BWPs.

According to an embodiment, the at least two BWPs correspond to at least one of the following situations: the first BWP and the second BWP share a configuration of the PDSCH and/or PUSCH and the first BWP and the second BWP share a configuration of a first parameter of the PDSCH and/or PUSCH, and a second parameter other than the first parameter is configured for the first BWP and the second BWP, respectively.

According to an embodiment, wherein the first BWP is configured to receive physical downlink control channel (PDCCH) or transmit physical uplink control channel (PUCCH).

According to an embodiment, the method comprises performing a repetitive reception or transmission of the PDSCH or PUSCH scheduled by the DCI on the at least two BWPs, respectively.

According to an embodiment, the method comprises determining a first transport block size (TBS) of the PDSCH or PUSCH transmitted on the at least two BWPs based on at least one of the following: an average number of resource elements (REs) determined based on the at least two BWPs, a maximum value among the numbers of REs respectively determined based on the at least two BWPs, a minimum value of the numbers of REs respectively determined based on the at least two BWPs, a number of REs determined based on a preset BWP of the at least two BWPs, and a scaling factor corresponding to the first TBS.

According to an embodiment, the method comprises determining redundancy versions (RVs) of the PDSCH or PUSCH on the at least two BWPs in at least one of the following manners: the RVs of the PDSCH or PUSCH on the at least two BWPs are identical, and the RVs are predefined, configured through a high layer signaling, or indicated through the DCI, the RV of the PDSCH or PUSCH on each BWP in the at least two BWPs is different, and each RV is predefined, configured through a high layer signaling, or indicated through the DCI, respectively, the RV t of the PDSCH or PUSCH on each BWP in the at least two BWPs is different, each RV is determined by an RV order, and each BWP in the at least two BWPs cyclically corresponds to each RV in the RV order successively, and the RV of the PDSCH or PUSCH on each BWP in the at least two BWPs is different, each RV is determined by an RV order and a starting RV, and each BWP in the at least two BWPs cyclically corresponds to each RV in the RV order successively from the starting RV. In an embodiment, the RV order is predefined or configured through a high layer signaling, and the starting RV is predefined, configured through a high layer signaling, or indicated through the DCI.

According to an embodiment, the method comprises performing a segmented reception or transmission of the PDSCH or PUSCH scheduled by the DCI on the at least two BWPs, respectively.

According to an embodiment, the method further comprises mapping the PDSCH or PUSCH scheduled by the DCI to a physical resource in at least one of the following manners: performing a first mapping in an order of frequency domain followed by time domain from a BWP with the lowest frequency in BWPs, and repeating the first mapping in the remaining BWPs, performing a second mapping in a frequency order from a first time unit in time units, and repeating the second mapping in the remaining time units, and performing a third mapping in a chronological order from a RE with the lowest frequency, and repeating the third mapping in the remaining REs.

According to an embodiment, the method further comprises determining a second TBS of the PDSCH or PUSCH transmitted on the at least two BWPs based on at least one of: a total number of REs determined based on the at least two BWPs, and a scaling factor corresponding to the second TBS.

According to an embodiment, the method further comprises in a first preset interval, switching from a BWP where a time unit before the first preset interval is located to a BWP where a time unit after the first preset interval is located, and continue receiving the PDSCH or transmitting the PUSCH scheduled by the DCI.

In accordance with an aspect of the disclosure, a user equipment in a communication system is provided. The user equipment comprises a transceiver, a memory, and a processor coupled with the transceiver, and the processor configured to receive downlink control information (DCI), the DCI including scheduling information of a physical downlink shared channel (PDSCH) or physical uplink shared channel (PUSCH) transmitted on at least two bandwidth parts (BWPs), wherein the at least two BWPs including one first BWP and at least one second BWP are configured in one serving cell, and receive the PDSCH or transmit PUSCH scheduled by the DCI on the at least two BWPs.

In accordance with an aspect of the disclosure, a method performed by a BS in a communication system includes transmitting downlink control information (DCI), the DCI including scheduling information of physical downlink shared channels (PDSCHs) or physical uplink shared channels (PUSCHs) transmitted on at least two bandwidth parts (BWPs), wherein the at least two BWPs including one first BWP and at least one second BWP are configured in one serving cell, and transmitting the PDSCH or receiving the PUSCH scheduled by the DCI on the at least two BWPs.

Although the operation steps are indicated by arrows in the flowcharts of the embodiments of the disclosure, the implementation order of these steps is not limited to the order indicated by the arrows. Unless otherwise explicitly stated herein, in some implementation scenarios of the embodiments of the disclosure, the implementation steps in the flowcharts may be executed in other orders as required. In addition, based on actual implementation scenarios, some or all of the steps in the flowcharts may include multiple sub-steps or multiple stages. Some or all of the sub-steps or stages may be executed at the same moment of time, and each of the sub-steps or stages may be executed at different moments of time. In scenarios with different execution moments, the execution order of these sub-steps or stages may be flexibly configured according to requirements, which is not limited in this embodiment of the disclosure.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method performed by a user equipment (UE) in a communication system, comprising:
receiving downlink control information (DCI), the DCI including scheduling information of a physical downlink shared channel (PDSCH) or physical uplink shared channel (PUSCH) transmitted on at least two bandwidth parts (BWPs), wherein the at least two BWPs including one first BWP and at least one second BWP are configured in one serving cell; and
receiving the PDSCH or transmitting the PUSCH scheduled by the DCI on the at least two BWPs.

2. The method according to claim 1,
wherein the at least two BWPs correspond to at least one of the following situations:
the first BWP and the second BWP share a configuration of the PDSCH and/or PUSCH; and
the first BWP and the second BWP share a configuration of a first parameter of the PDSCH and/or PUSCH, and a second parameter other than the first parameter is configured for the first BWP and the second BWP, respectively.

3. The method according to claim 1,
wherein the first BWP is configured to receive physical downlink control channel (PDCCH) or transmit physical uplink control channel (PUCCH).

4. The method according to claim 1, wherein receiving the PDSCH or transmitting the PUSCH scheduled by the DCI on the at least two BWPs comprises:
performing a repetitive reception or transmission of the PDSCH or PUSCH scheduled by the DCI on the at least two BWPs, respectively.

5. The method according to claim 4, wherein the method further comprises:
determining a first transport block size (TBS) of the PDSCH or PUSCH transmitted on the at least two BWPs based on at least one of the following:
an average number of resource elements (REs) determined based on the at least two BWPs;
a maximum value among the numbers of REs respectively determined based on the at least two BWPs;
a minimum value of the numbers of REs respectively determined based on the at least two BWPs;
a number of REs determined based on a preset BWP of the at least two BWPs; and
a scaling factor corresponding to the first TBS.

6. The method according to claim 4, wherein the method further comprises:
determining redundancy versions (RVs) of the PDSCH or PUSCH on the at least two BWPs in at least one of the following manners:
the RVs of the PDSCH or PUSCH on the at least two BWPs are identical, and the RVs are predefined, configured through a high layer signaling, or indicated through the DCI;
the RV of the PDSCH or PUSCH on each BWP in the at least two BWPs is different, and each RV is predefined, configured through a high layer signaling, or indicated through the DCI, respectively;
the RV of the PDSCH or PUSCH on each BWP in the at least two BWPs is different, each RV is determined by an RV order, and each BWP in the at least two BWPs cyclically corresponds to each RV in the RV order successively; and
the RV of the PDSCH or PUSCH on each BWP in the at least two BWPs is different, each RV is determined by an RV order and a starting RV, and each BWP in the at least two BWPs cyclically corresponds to each RV in the RV order successively from the starting RV,
wherein the RV order is predefined or configured through a high layer signaling, and
wherein the starting RV is predefined, configured through a high layer signaling, or indicated through the DCI.

7. The method according to claim 1, wherein receiving the PDSCH or transmitting the PUSCH scheduled by the DCI on the at least two BWPs comprises:
performing a segmented reception or transmission of the PDSCH or PUSCH scheduled by the DCI on the at least two BWPs, respectively.

8. The method according to claim 7, wherein the method further comprises:
mapping the PDSCH or PUSCH scheduled by the DCI to a physical resource in at least one of the following manners:
performing a first mapping in an order of frequency domain followed by time domain from a BWP with the lowest frequency in BWPs, and repeating the first mapping in the remaining BWPs;
performing a second mapping in a frequency order from a first time unit in time units, and repeating the second mapping in the remaining time units; and
performing a third mapping in a chronological order from a RE with the lowest frequency, and repeating the third mapping in the remaining REs.

9. The method according to claim 7, wherein the method further comprises:
determining a second TBS of the PDSCH or PUSCH transmitted on the at least two BWPs based on at least one of:
a total number of REs determined based on the at least two BWPs, and
a scaling factor corresponding to the second TBS.

10. The method according to claim 1, wherein receiving of the PDSCH or transmitting of the PUSCH scheduled by the DCI on the at least two BWPs comprises:
in a first preset interval, switching from a BWP where a time unit before the first preset interval is located to a BWP where a time unit after the first preset interval is located, and
continue receiving the PDSCH or transmitting the PUSCH scheduled by the DCI.

11. A user equipment (UE) in a communication system, the UE comprising:
a transceiver;
a memory; and
a processor coupled to the transceiver, and configured to:
receive downlink control information (DCI), the DCI including scheduling information of a physical downlink shared channel (PDSCH) or physical uplink shared channel (PUSCH) transmitted on at least two bandwidth parts (BWPs), wherein the at least two BWPs including one first BWP and at least one second BWP are configured in one serving cell, and
receive the PDSCH or transmit the PUSCH scheduled by the DCI on the at least two BWPs.

12. The UE according to claim 11,
wherein the at least two BWPs correspond to at least one of the following situations:
the first BWP and the second BWP share a configuration of the PDSCH and/or PUSCH; and
the first BWP and the second BWP share a configuration of a first parameter of the PDSCH and/or PUSCH, and a second parameter other than the first parameter is configured for the first BWP and the second BWP, respectively.

13. The UE according to claim 11,
wherein the first BWP is configured to receive physical downlink control channel (PDCCH) or transmit physical uplink control channel (PUCCH).

14. The UE according to claim 11, wherein the processor is configured to:
perform a repetitive reception or transmission of the PDSCH or PUSCH scheduled by the DCI on the at least two BWPs, respectively.

15. The UE according to claim 14, wherein the processor is further configured to:
determine a first transport block size (TBS) of the PDSCH or PUSCH transmitted on the at least two BWPs based on at least one of the following:
an average number of resource elements (REs) determined based on the at least two BWPs;
a maximum value among the numbers of REs respectively determined based on the at least two BWPs;
a minimum value of the numbers of REs respectively determined based on the at least two BWPs;
a number of REs determined based on a preset BWP of the at least two BWPs; and
a scaling factor corresponding to the first TBS.

16. The UE according to claim 14, wherein the processor is further configured to:
determine redundancy versions (RVs) of the PDSCH or PUSCH on the at least two BWPs in at least one of the following manners:
the RVs of the PDSCH or PUSCH on the at least two BWPs are identical, and the RVs are predefined, configured through a high layer signaling, or indicated through the DCI;
the RV of the PDSCH or PUSCH on each BWP in the at least two BWPs is different, and each RV is predefined, configured through a high layer signaling, or indicated through the DCI, respectively;
the RV of the PDSCH or PUSCH on each BWP in the at least two BWPs is different, each RV is determined by an RV order, and each BWP in the at least two BWPs cyclically corresponds to each RV in the RV order successively; and
the RV of the PDSCH or PUSCH on each BWP in the at least two BWPs is different, each RV is determined by an RV order and a starting RV, and each BWP in the at least two BWPs cyclically corresponds to each RV in the RV order successively from the starting RV,
wherein the RV order is predefined or configured through a high layer signaling, and
wherein the starting RV is predefined, configured through a high layer signaling, or indicated through the DCI.

17. The UE according to claim 11, wherein the processor is configured to:
perform a segmented reception or transmission of the PDSCH or PUSCH scheduled by the DCI on the at least two BWPs, respectively.

18. The UE according to claim 17, wherein the processor is further configured to:
map the PDSCH or PUSCH scheduled by the DCI to a physical resource in at least one of the following manners:
perform a first mapping in an order of frequency domain followed by time domain from a BWP with the lowest frequency in BWPs, and repeating the first mapping in the remaining BWPs;
perform a second mapping in a frequency order from a first time unit in time units, and repeating the second mapping in the remaining time units; and
perform a third mapping in a chronological order from a RE with the lowest frequency, and repeating the third mapping in the remaining REs.

19. The UE according to claim 7, wherein the processor is further configured to:
determine a second TBS of the PDSCH or PUSCH transmitted on the at least two BWPs based on at least one of:
a total number of REs determined based on the at least two BWPs, and
a scaling factor corresponding to the second TBS.

20. A method performed by a base station in a communication system, comprising:
transmitting downlink control information (DCI), the DCI including scheduling information of physical downlink shared channels (PDSCHs) or physical uplink shared channels (PUSCHs) transmitted on at least two bandwidth parts (BWPs), wherein the at least two BWPs including one first BWP and at least one second BWP are configured in one serving cell; and
transmitting the PDSCH or receiving the PUSCH scheduled by the DCI on the at least two BWPs.
